(19) United States
(12) Patent Application Publication
(10) Pub. No.: US 2024/0195594 A1
(43) Pub. Date: Jun. 13, 2024

(54) User Equipment, Network Node and Methods in a Wireless Communications Network

(71) Applicant: Telefonaktiebolaget LM Ericsson (publ), Stockholm (SE)

(72) Inventors: Lian Araujo, Solna (SE); Icaro Leonardo Da Silva, Solna (SE); Cecilia Eklöf, Täby (SE); Jens Bergqvist, Linköping (SE); Zhenhua Zou, Solna (SE); Pontus Wallentin, Linköping (SE)

(21) Appl. No.: 18/553,296

(22) PCT Filed: Mar. 21, 2022
(86) PCT No.: PCT/SE2022/050267

§ 371 Date: Sep. 29, 2023

Related U.S. Application Data
(60) Provisional application No. 63/169,261, filed on Apr. 1, 2021.

(51) Int. Cl. H04L 5/00; H04W 24/02

(52) U.S. Cl. CPC H04L 5/0098; H04W 24/02

(57) ABSTRACT

A method performed by a User Equipment (UE) for handling for handling Secondary Cell Group (SCG) operation in a wireless communications network is provided. The UE determines (402) a preferred mode of operation associated to an SCG. The UE transmits (403) a message to a network node. The message comprises the determined preferred mode of operation associated to the SCG.

### TECHNICAL FIELD

Embodiments herein relate to a User Equipment (UE), a network node and methods therein. In some aspects they relate to handling operation of a Secondary Cell Group (SCG) in a wireless communications network.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e., they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

FIG. 1 illustrates a dormancy like behavior for Secondary Cells (SCell) in NR. 3GPP has specified the concepts of dormant SCell, in LTE, and dormancy like behavior of an SCell, for NR. In LTE, when an SCell is in dormant state, like in the deactivated state, the UE does not need to monitor the corresponding Physical Downlink Control Channel (PDCCH) or Physical Downlink Shared Channel (PDSCH) and cannot transmit in the corresponding uplink. However, differently from deactivated state, the UE is required to perform and report Channel Quality Indicator (CQI) measurements. A Physical Uplink Control Channel (PUCCH) SCell, SCell configured with PUCCH, cannot be in dormant state. In NR, dormancy like behaviour for SCells is realized using the concept of dormant Bandwidth Parts (BWPs). One dormant BWP, which is one of the dedicated BWPs configured by the network via Radio Resource Control (RRC) signaling, can be configured for an SCell. If the active BWP of the activated SCell is a dormant BWP, the UE stops monitoring PDCCH on the SCell but continues performing Channel State Information (CSI) measurements, Automatic Gain Control (AGC) and beam management, if configured. A Downlink Control Information (DCI) is used to control entering/leaving the dormant BWP for one or more SCell(s) or one or more SCell group(s), and it is sent to the special cell (sPCell) of the cell group that the SCell belongs to, i.e. Primary (PCell) in case the SCell belongs to the Master Cell Group (MCG) and Primary Secondary Cell (PSCell) if the SCell belongs to the SCG. The SpCell, i.e. PCell of PSCell, and PUCCH SCell cannot be configured with a dormant BWP.

However, only SCells can be put to put in dormant state in LTE, or operate in dormancy like behavior in NR. Also, only SCells can be put into the deactivated state in both LTE and NR. Thus, if the UE is configured with MR-DC, it is not possible to fully benefit from the power saving options of dormant state or dormancy like behavior as the PSCell cannot be configured with that feature. Instead, an existing solution may be releasing, for power savings, and adding, when traffic demands requires, the SCG on a need basis. However, traffic is likely to be bursty, and adding and releasing the SCG involves a significant amount of RRC signaling and inter-node messaging between the MN and the SN, which causes considerable delay.

In Release 16 (Rel-16), some discussions were made regarding putting also the PSCell in dormancy, also referred to as SCG Suspension. Some preliminary agreements were made in RAN2-107bis, October 2019, see chairman notes at R2-1914301:

RAN2 assumes the following, which may be slightly modified due to progress on Scell dormancy:
The UE supports network-controlled suspension of the SCG in RRC_CONNECTED.
The UE behavior for a suspended SCG is For Further Study (FFS).
The UE supports at most one SCG configuration, suspended or not suspended, in Rel-16.
In RRC_CONNECTED, upon addition of the SCG, the SCG can be either suspended or not suspended by configuration.

In RAN2 #108, further discussion was made to clarify the above FFSs. Some solutions have been proposed in Rel-16, but these have different problems. For example, in R2-1908679, Introducing suspension of SCG-Qualcomm, the paper proposes that a gNB can indicate a UE to suspend SCG transmissions when no data traffic is expected to be sent in SCG so that UE keeps the SCG configuration but does not use it for power saving purpose. Therein, it is mentioned that signaling to suspend SCG may be based on DCI/Medium Access Control Control Element (MAC-CE)/RRC signaling, but no details were provided regarding the configuration from the gNB to the UE. And, differently from the defined behavior for SCell(s), PSCell may be associated to a different network node, e.g. a gNB operating as Secondary Node (SN).

### UE Assistance Information

In order to optimize the user experience and, for instance, to assist the network in configuring connected mode parameters and connection release handling, the UE may be configured to send assistance information to the network. The network response to the UE assistance information is left to network implementation.

The network may configure the UE to provide multiple information, such as overheating indication and UE power saving preferences. Such information can be provided for both LTE and NR nodes, and some of them can also be configured and provided in MR-DC context. The framework for power saving in NR-DC is provided below with excerpts from 3GPP TS 38.331, but a similar framework is also applicable for other MR-DC options.

### 3GPP TS 38.331 5.7.4.1 General

FIG. 2 depicts FIG. 5.7.4.1-1: UE Assistance Information in 3GPP TS 38.331. The purpose of this procedure is for the UE to inform the network of:
its delay budget report carrying desired increment/decrement in the connected mode DRX cycle length, or;
its overheating assistance information, or;
its IDC assistance information, or;
its preference on DRX parameters for power saving, or;
its preference on the maximum aggregated bandwidth for power saving, or;
its preference on the maximum number of secondary component carriers for power saving, or;
its preference on the maximum number of MIMO layers for power saving, or;
its preference on the minimum scheduling offset for cross-slot scheduling for power saving, or;
its preference on the RRC state, or;
configured grant assistance information for NR sidelink communication, or;
its preference in being provisioned with reference time information.
1> if configured to provide its preference on the maximum number of secondary component carriers of a cell group for power saving:
   2> if the UE has a preference on the maximum number of secondary component carriers of the cell group and the UE did not transmit a UEAssistanceInformation message with maxCC-Preference for the cell group since it was configured to provide its preference on the maximum number of secondary component carriers of the cell group for power saving; or
   2> if the current maxCC-Preference information for the cell group is different from the one indicated in the last transmission of the UEAssistanceInformation message including maxCC-Preference for the cell group and timer T346c associated with the cell group is not running:
      3> start the timer T346c with the timer value set to the maxCC-PreferenceProhibitTimer of the cell group;
      3> initiate transmission of the UEAssistanceInformation message in accordance with 5.7.4.3 to provide the current maxCC-Preference;
1> if configured to provide its release preference and timer T346f is not running:
   2> if the UE determines that it would prefer to transition out of RRC_CONNECTED state; or
   2> if the UE is configured with connectedReporting and the UE determines that it would prefer to revert an earlier indication to transition out of RRC_CONNECTED state:
      3> start timer T346f with the timer value set to the releasePreferenceProhibitTimer,
      3> initiate transmission of the UEAssistanceInformation message in accordance with 5.7.4.3 to provide the release preference;

### 3GPP TS 38.331 5.7.4.3 Actions Related to Transmission of UEAssistanceInformation Message

The UE shall set the contents of the UEAssistanceInformation message as follows:
1> if transmission of the UEAssistanceInformation message is initiated to provide maxCC-Preference of a cell group for power saving according to 5.7.4.2 or 5.3.5.3:
   2> include maxCC-Preference in the UEAssistanceInformation message;
   2> if the UE has a preference on the maximum number of secondary component carriers for the cell group:
      3> include reducedMaxCCs in the MaxCC-Preference IE;
      3> set reducedCCsDL to the number of maximum SCells the UE desires to have configured in downlink in the cell group;
      3> set reducedCCsUL to the number of maximum SCells the UE desires to have configured in uplink in the cell group;
   2> else (if the UE has no preference on the maximum number of secondary component carriers for the cell group):
      3> do not include reducedMaxCCs in the MaxCC-Preference IE;

NOTE 3: The UE can implicitly indicate a preference for NR SCG release by reporting the maximum aggregated bandwidth preference for power saving of the cell group, if configured, as zero for both FR1 and FR2, and by reporting the maximum number of secondary component carriers for power saving of the cell group, if configured, as zero for both uplink and downlink.
1> if transmission of the UEAssistanceInformation message is initiated to provide a release preference according to 5.7.4.2 or 5.3.5.3:
   2> include releasePreference in the UEAssistanceInformation message;
   2> set preferredRRC-State to the desired RRC state on transmission of the UEAssistanceInformation message;

The UE shall:
1> if the procedure was triggered to provide configured grant assistance information for NR sidelink communication by an NR RRCReconfiguration message that was embedded within an E-UTRA RRCConnectionReconfiguration:
   2> submit the UEAssistanceInformation to lower layers via SRB1, embedded in E-UTRA RRC message ULInformation TransferIRAT as specified in TS 36.331 [10], clause 5.6.28;
1> else if the UE is in (NG)EN-DC:
   2> if SRB3 is configured:
      3> submit the UEAssistanceInformation message via SRB3 to lower layers for transmission;
   2> else:
      3> submit the UEAssistanceInformation message via the E-UTRA MCG embedded in E-UTRA RRC message ULInformation TransferMRDC as specified in TS 36.331 [10].
1> else if the UE is in NR-DC:
   2> if the UE assistance configuration that triggered this UE assistance information is associated with the SCG:
      3> if SRB3 is configured:
         4> submit the UEAssistanceInformation message via SRB3 to lower layers for transmission;
      3> else:
         4> submit the UEAssistanceInformation message via the NR MCG embedded in NR RRC message ULInformationTransferMRDC as specified in 5.7.2a.3;
   2> else:
      3> submit the UEAssistanceInformation message via SRB1 to lower layers for transmission;
1> else:
   2> submit the UEAssistanceInformation message to lower layers for transmission.

### SUMMARY

An object of embodiments herein is to improve power saving and/or radio resource saving of UEs and network nodes operating in a wireless communications network.

According to an aspect of embodiments herein, the object is achieved by a method performed by a User Equipment (UE), for handling Secondary Cell Group (SCG) operation in a wireless communications network. The UE determines the preferred mode of operation associated to an SCG. The preferred mode of operation associated to the SCG is anyone or more out of: An added SCG, an activated SCG, a deactivated SCG or a released SCG. The UE transmits to a network node, a message comprising a determined preferred mode of operation associated to the SCG.

According to another aspect of embodiments herein, the object is achieved by a method performed by the network node, for handling SCG operation in the wireless communications network. The network node receives from the UE, a message comprising a determined preferred mode of operation associated to an SCG.

According to another aspect of embodiments herein, the object is achieved by the UE. The UE is configured to handle SCG operation in the wireless communications network. The UE is further configured to:
Determine a preferred mode of operation associated to an SCG, which preferred mode of operation associated to the SCG is adapted to be anyone or more out of: An added SCG, an activated SCG, a deactivated SCG or a released SCG, and
transmit to the network node, a message adapted to comprise a determined preferred mode of operation associated to the SCG.

According to another aspect of embodiments herein, the object is achieved by the network node. The network node is configured to handle SCG operation in the wireless communications network. The network node is further configured to:
Receive, from the UE, a message adapted to comprise a determined preferred mode of operation associated to an SCG.

Embodiments herein target to handle SCG operations. The UE determines a preferred mode of operation associated to the SCG and then transmits the preferred mode of operation associated to an SCG to the network node. This enables the UE to indicate its preference of SCG operation to the network.

Embodiments herein brings the advantage of an efficient mechanism to improve network energy efficiency and/or radio resource saving of UEs and network nodes in the wireless communications network. This is achieved by the UE transmitting a message comprising a preferred mode of operation associated to the SCG. The preferred mode of operation is determined by the UE. The message is transmitted to a network node in the wireless communications network. This leads to an increased flexibility in handling SCG operations, which results in an improved network energy efficiency and power savings in the UE and may also free up radio and/or network node resources.

### BRIEF DESCRIPTION OF THE DRAWINGS

Examples of embodiments herein are described in more detail with reference to attached drawings in which:

FIG. 1 illustrates an example of dormancy like behavior for Secondary Cells according to prior art.

FIG. 2 is a signaling diagram illustrating an example according to prior art.

FIG. 3 is a schematic block diagram illustrating embodiments of a wireless communications network.

FIG. 4 is a flowchart depicting embodiments of a method in a UE.

FIG. 5 is a flowchart depicting embodiments of a method in a network node.

FIGS. 6 a and b are schematic block diagrams illustrating embodiments of a UE.

FIGS. 7 a and b are schematic block diagrams illustrating embodiments of a network node.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10 to 13 are flowcharts illustrating methods implemented in a communication system including a host computer, a base station and a user equipment.

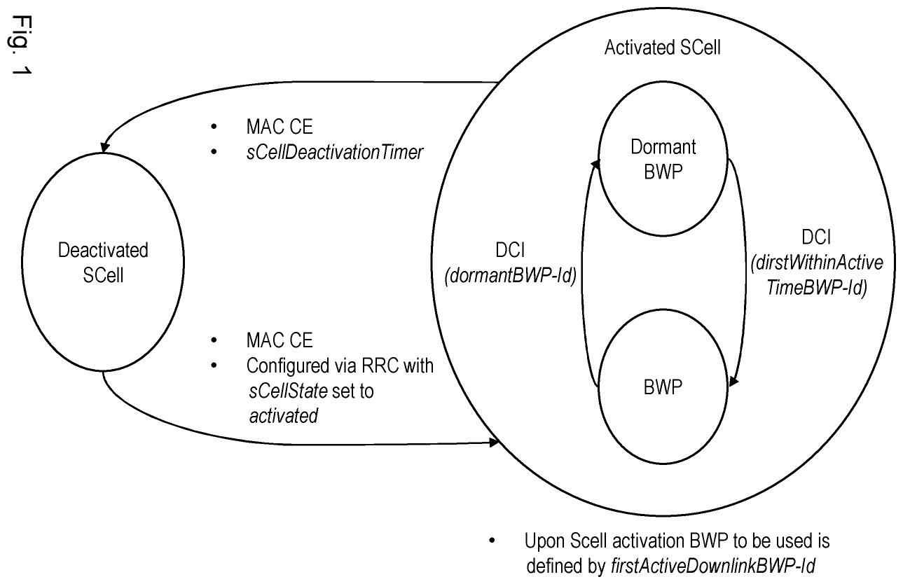

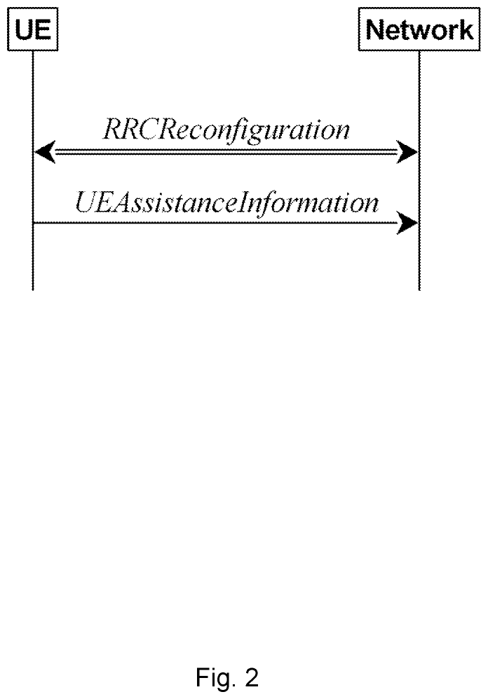

### DETAILED DESCRIPTION

As a part of developing embodiments herein the inventors identified a problem which first will be discussed.

In order to improve network energy efficiency and UE battery life for UEs in Multi-Radio Dual Connectivity (MR-DC), a Release 17 (Rel-17) work item is planned to introduce efficient Secondary Cell Group (SCG) activation and/or deactivation. This may be especially important for MR-DC configurations with NR SCG, as it has been evaluated in RP-190919 that in some cases NR UE power consumption is 3 to 4 times higher than LTE.

It is yet to be seen which behavior will be specified for SCG power saving in Rel-17. However, it may e.g. be one or more of the following:
The UE is starting to operate the PSCell in dormancy, e.g. switching the PSCell to a dormant BWP. On the network side, the network considers the PSCell in dormancy and at least stops transmitting PDCCH for that UE in the PSCell and SCells.
The UE is deactivating the PSCell like SCell deactivation. On the network side, the network considers the PSCell as deactivated and at least stops transmitting PDCCH for that UE in the PSCell, and also on the SCells.
The UE is operating the PSCell in long Discontinuous Reception (DRX). SCG DRX can be switched off from the Master Node (MN), e.g. via MCG RRC, MAC-CE or DCI, when the need arises, e.g. Downlink (DL) data arrival for SN terminated SCG bearers.
The UE is suspending its operation with the SCG, e.g. suspending bearers associated with the SCG, like SCG MN-/SN-terminated bearers, but keeping the SCG configuration stored, referred to as Stored SCG. On the network side there can be different alternatives such as the SN storing the SCG as the UE does, or the SN releasing the SCG context of the UE to be generated again upon resume, e.g. with the support from the MN that is the node storing the SCG context for that UE whose SCG is suspended.

Though the power saving aspect is so far discussed from the SCG point of view, it is likely that similar approaches may be used on the MCG as well, e.g. the MCG maybe suspended or in long DRX, while data communication is happening only via the SCG.

Currently the UE can only indicate its preference to either enter IDLE or INACTIVE state e.g. when the UE stays for some time without data in its uplink buffer and/or when the UE knows that a certain application, e.g. a smartphone application, is likely not going to be accessed so that downlink traffic is not going to be triggered for that UE.

If a UE is capable of MR-DC, such information is not sufficient to indicate to the network whether an MR-DC capable UE prefers to configure MR-DC, e.g. based on power savings settings and/or traffic demands in DL and/or UL, or whether it prefers to release MR-DC, in case it is configured with MR-DC. For releasing MR-DC, the only assistance information standardized is the transmission of an SCG failure report, that is triggered only upon an SCG failure, or the indication to the SN of a UE preference, due to power saving, to have no serving cell configured for the SCG. In addition to this limitation, with the introduction of the Release 17 feature of SCG deactivation, there may be additional degrees of freedom for the network e.g. to activate and/or deactivate the SCG.

An object of embodiments herein may e.g. be to improve power saving and/or radio resource saving of UEs and network nodes operating in a wireless communications network.

Embodiments herein enables UEs to indicate its preference of SCG operation to the network. This in turn may save UE and network power, prevent UE overheating and may also free radio and/or network node resources to be used for other UEs. It may also free UE hardware resources and reduce UE battery drain.

Some examples of embodiments provided herein target to handle UE, also referred to as a wireless terminal, actions for handling SCG operations. In such a case, a UE will first determine a preferred mode of operation associated to a SCG. Then, the UE will transmit a message comprising the determined preferred mode of operation associated with the SCG to a network node. The message may be transmitted when a triggering condition, such as e.g. a handover, a resume, a re-establishment, etc., is fulfilled. The determined mode of operation associated to the SCG may e.g. be one or more out of activate a SCG, deactivate a SCG, add a SCG and release a SCG.

Some further examples of embodiments provided herein target to handle network node, also referred to as gNodeB or gNB, actions for handling SCG operations. In such a case, a network node may receive a message from a UE. The message comprises a preferred mode of operation associated to the SCG. The network node may, in response to receiving the message from the UE, transmit a message to the UE. The message is related to the received preferred mode of operation associated to the SCG determined by the UE.

Embodiments herein enables UEs to indicate its preference of SCG operation to the network. This in turn may save UE and network power, prevent UE overheating and may also free radio and/or network node resources to be used for other UEs. It may also free UE hardware resources and reduce UE battery drain.

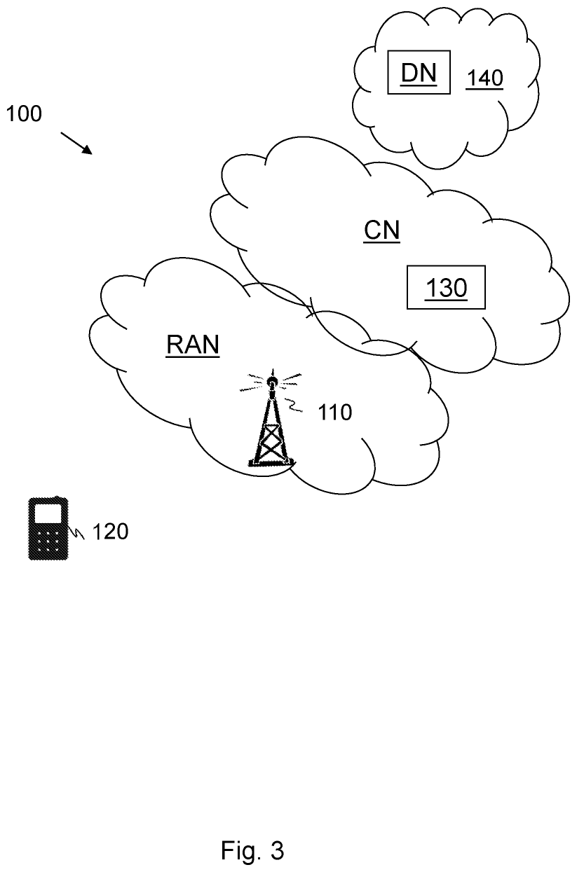

FIG. 3 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The network node 110 e.g. provides a number of cells referred to as cell1 and cell2 (not shown) and may use these cells for communicating with e.g. a UE 120. The network node 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any of cell1 and cell2 served by the network node 110 depending e.g. on the radio access technology and terminology used. The network node 110 may be part of an MCG or an SCG. The SCG and the MCG may comprise other network nodes (not shown).

User Equipments operate in the wireless communications network 100, such as a UE 120. The UE 120 may provide radio coverage by means of a number of antenna beams.

The UE 120 may e.g. be an NR device, a mobile station, a wireless terminal, an NB-loT device, an eMTC device, an NR RedCap device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

CN nodes such as a CN node 130 operates in the wireless communications network 100.

Methods herein may in one aspect be performed by the network node 110 and in another aspect by the UE 120. As an alternative, a Distributed Node (DN) and functionality, e.g. comprised in a cloud 140 as shown in FIG. 3, may be used for performing or partly performing the methods.

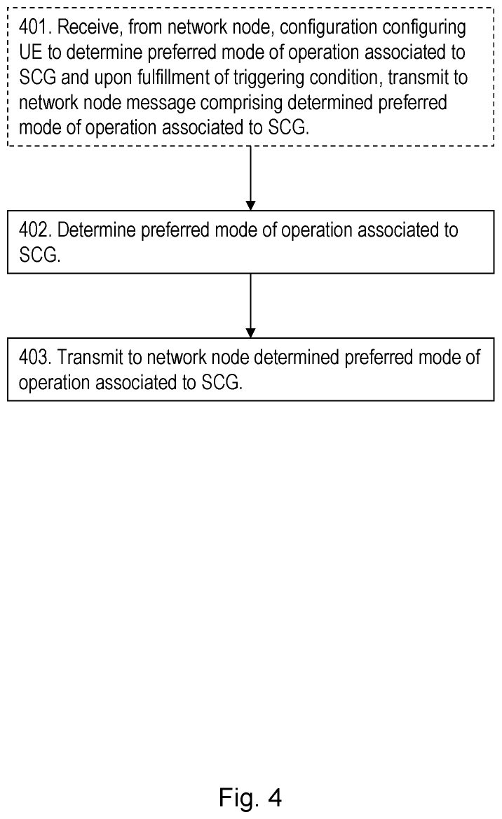

FIG. 4 shows an example method performed by the UE 120, also referred to as a wireless terminal 120, e.g. for saving energy by e.g. handling SCG operation in a wireless communications network 100.

According to an example scenario of embodiments herein, handling SCG operations may relate to activating or deactivating the SCG for the UE 120, adding or releasing the SCG for the UE 120, or any combination thereof.

In other words, the UE 120 determines (402) a preferred mode of operation associated to the SCG and indicates (403) this to the network node 110 and is thus handling the SCG operation. According to embodiments herein, by determining a preferred mode of operation associated to the SCG and indicating it to the network node 110, the network node 110 knows the UE 120 preferences, which may save energy in both the UE 120 and the network node 110, prevent overheating in the UE 120, and also reduce radio resource usage increasing the performance of the wireless communication network. This is since by indicating to the network node 110 the preferred mode of operation associated to the SCG of the UE 110, the network node may change the mode of operation associated to the SCG accordingly, such as activating, deactivating, adding or releasing the SCG. In this way the network node 110 and the UE 120 may operate according to a mode of operation that the UE 120 prefers, and may e.g. only use energy and radio resources when they are needed or preferred

The method comprises any one or more out of the actions below:

### Action 401

In some embodiments, the UE 120 receives a configuration from a network node 110. The configuration configures the UE 120 to determining a preferred mode of operation associated to an SCG. The configuration may further configure the UE 120 to, upon the fulfillment of a triggering condition, transmit to the network node 110, a message comprising the determined preferred mode of operation associated to the SCG.

The UE 110 may be configured to transmit the determined preferred mode of operation associated to the SCG. It may be transmitted to the network node 110 as UE assistance information.

The triggering condition may e.g., be any one or more out of: A timer, the current mode of operation associated to the SCG is different from the determined preferred mode of operation associated to the SCG, a cause value, a handover to a target cell, a reconfiguration that is not related to a handover, a connection setup, a re-establishment procedure, a resume procedure or a suspend procedure.

Receiving, when used herein, may e.g., mean sending or in any other way providing the message to the network node. This definition is however not limited to this specific example but holds for any use of the word receiving herein.

### Action 402

In order to handle the SCG operations, the UE 120 may need to determine a preferred mode of operation associated to the SCG.

The UE 120 determines a preferred mode of operation associated to an SCG. The preferred mode of operation associated to SCG is e.g. anyone or more out of: An added SCG, an activated SCG, a deactivated SCG or a released SCG. According to this, the UE 120 may determine a preferred mode of operation associated to the SCG that is most efficient for the UE 120 e.g. related to energy consumption, mobility, data transmissions or the like. In other words, the UE 120 may check which mode of operation associated to the SCG that is most efficient for the UE 120 use, related to e.g. expected energy consumption, mobility, data transmissions or the like.

In some example scenarios, the UE 120 determines that the preferred mode of operation associated to the SCG is to activate the SCG. This may mean that the UE 120 have previously determined the preferred mode of operation associated to the SCG was to deactivate the SCG, and now prefer the SCG to be activated.

In some other example scenarios, the UE 120 may determine that the preferred mode of operation associated to the SCG is to deactivate the SCG. This may mean that the UE 120 has the SCG activated and now prefers to deactivate the SCG. Or it may mean that the UE 120 has no preference on whether the activated SCG is deactivated, released, or reconfigured.

In some embodiments, the determining comprises that the UE 120 determines whether an SCG is to be added, kept or released. When determined that an SCG is to be added or kept, the UE 120 may further determine whether the added or kept SCG is to be activated or deactivated.

This may mean that when an SCG is to be added or kept, the preferred mode of operation further comprises whether the added or kept SCG is to be activated or deactivated. In other words, an added or kept SCG may either be activated or deactivated according to the preferred mode of operation.

This may in some example scenarios mean that the UE 120 prefers to add the SCG and that the preferred mode of operation associated to the SCG is to activate or deactivate the added SCG.

As an alternative it may in some other example scenarios mean that the UE 120 has previously added the SCG and that the preferred mode of operation associated to the SCG is to activate or deactivate the previously added SCG.

As an alternative it may in yet some other example scenarios mean that the UE 120 has previously added the SCG and that the preferred mode of operation associated to the SCG is to release the SCG.

An added SCG when used herein, may mean that the SCG is configured for the UE 120. Adding a SCG when used herein may mean configuring the SCG to the UE 120.

### Action 403

To improve the power saving of UEs, such as the UE 120, and network nodes, such as the network node 110, operating in the wireless communications network 100, the network node 110 requires knowing about the determined preferred mode of operation associated to the SCG if it to be used.

Therefore, upon the fulfillment of a triggering condition, the UE 120 transmits a message to the network node 110. The message comprises the determined preferred mode of operation associated to the SCG. In this way, the SCG operations are efficiently handled.

As mentioned above. the determined preferred mode of operation associated to the SCG may be transmitted to the network node 110 as UE assistance information.

In some embodiments, the determined preferred mode of operation associated to the SCG may be transmitted to the network node 110 as part of any one out of an overheating indication or UE power saving preferences.

As mentioned above, the triggering condition may e.g., be any one or more out of: A timer, the current mode of operation associated to the SCG is different from the determined preferred mode of operation associated to the SCG, a cause value, a handover to a target cell, a reconfiguration that is not related to a handover, a connection setup, a re-establishment procedure, a resume procedure or a suspend procedure. The triggering condition may be configured by the network node 110.

In other words, the UE 120 may indicate the preferred mode of operation to the network node 110 based on one or more of the above-mentioned triggering conditions.

The preferred mode of operation associated to the SCG may be comprised in message transmitted to the network node 110.

Transmitting, when used herein, may e.g., mean sending or in any other way providing e.g., the message to the network node 110. This definition is however not limited to this specific example but holds for any use of the word transmitting herein.

### Action 404

In some embodiments, in response to the network node 110 receiving the message comprising the determined preferred mode of operation associated to an SCG, the UE 120 may receive a message from the network node 110. The message comprises an indication indicating that the mode of operation associated to the SCG is changed to the preferred mode of operation associated to the SCG determined by the UE 120.

The indication may indicate any one or more out of: The SCG has been added, the SCG has been released, the SCG has been activated, the SCG has been deactivated, the SCG has been changed e.g., from a previously added SCG, suspending an RRC connection and releasing the RRC connection.

When indicating any one or more out of: Adding, releasing, activating, deactivating or changing the SCG, the indication may be comprised in e.g., an RRC reconfiguration message.

When indicating suspending the SCG the indication may be comprised in e.g., an RRC release message comprising a suspend Configuration (suspendConfig) indication to suspend the SCG.

When indicating releasing the SCG the indication may be comprised in e.g., an RRC release message.

When indicating adding the SCG, the indication may further indicate e.g., to add the SCG, to setup MR-DC or both.

When indicating releasing the SCG, the indication may further indicate e.g., to release the SCG, to release MR-DC or both.

When indicating activating the SCG, the indication may further indicate e.g., to activate the SCG.

When indicating deactivating the SCG, the indication may further indicate e.g., to deactivate the SCG.

When indicating changing the SCG, the indication may further indicate e.g., to change the SCG.

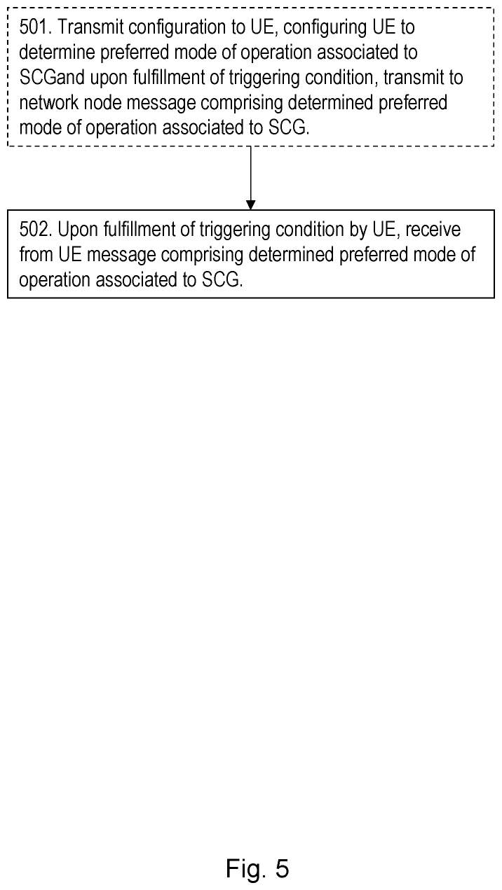

FIG. 5 shows an example method performed by a network node 110, e.g., for saving energy by e.g., handling SCG operation in a wireless communications network 100.

According to an example scenario of embodiments herein and as mentioned above, handling SCG operations may relate to activating or deactivating the SCG for the UE 120, adding or releasing the SCG for the UE 120, or any combination thereof. In other words, the UE 120 determines (402) a preferred mode of operation associated to the SCG and indicates (502) this to the network node 110 and is thus handling the SCG operation. According to embodiments herein, by determining a preferred mode of operation associated to the SCG and indicating it to the network node 110, the network node 110 knows the UE 120 preferences, which may save energy in both the UE 120 and the network node 110, prevent overheating in the UE 120, and also reduce radio resource usage increasing the performance of the wireless communication network.

This is since by indicating to the network node 110 the preferred mode of operation associated to the SCG of the UE 110, the network node 110 may change the mode of operation associated to the SCG accordingly, such as activating, deactivating, adding or releasing the SCG. This way the network node 110 and the UE 120 may operate according to a mode of operation that the UE 120 prefers and may e.g., only use energy and radio resources when they are needed or preferred.

The network node 110 may e.g. be any one out of: a Master Node or a Secondary Node.

The method comprises any one or more out of the actions below:

### Action 501

In some embodiments, the network node 110 configures the UE 120, e.g., by transmitting a configuration to the UE 120. The configuration configures the UE 120 to determining a preferred mode of operation associated to an SCG. The configuration may further be configured to the UE 120 to, upon the fulfilment of a triggering condition, transmit to the network node 110, a message comprising the determined preferred mode of operation associated to the SCG.

As mentioned above, the triggering condition may e.g., be any one or more out of: A timer, the current mode of operation associated to the SCG is different from the determined preferred mode of operation associated to the SCG, a cause value, a handover to a target cell, a reconfiguration that is not related to a handover, a connection setup, a re-establishment procedure, a resume procedure or a suspend procedure.

### Action 502

To improve the power saving of UEs, such as the UE 120, and network nodes, such as the network node 110, operating in the wireless communications network 100, the network node 110 requires knowing about the determined preferred mode of operation associated to the SCG if it to be used.

Upon the fulfilment of a triggering condition by UE 120, the network node 110 receives from the UE 120, a message comprising a determined preferred mode of operation associated to an SCG. The determined preferred mode of operation associated to SCG may e.g., be anyone or more out of: An added SCG, an activated SCG, a deactivated SCG or a released SCG. In this way, the SCG operations may be handled efficiently.

As mentioned above. the determined preferred mode of operation associated to the SCG may be received from the UE 120 as UE assistance information.

In some embodiments, the determined preferred mode of operation associated to the SCG may be received from the UE 120 as part of any one out of an overheating indication or UE power saving preferences.

As mentioned above, when the preferred mode of operation is an added or kept SCG, this may mean that the preferred mode of operation further comprises whether the added or kept SCG is to be activated or deactivated. In other words, an added or kept SCG may either be activated or deactivated according to the preferred mode of operation.

In other words, the UE 120 may indicate the preferred mode of operation to the network node 110 based on one or more triggering conditions, such as the one or more of the triggering conditions mentioned above. The preferred mode of operation associated to the SCG may be comprised in the message received from the UE 120.

### Action 503

In response to receiving the message comprising the determined preferred mode of operation associated to an SCG, the network node 110 may in some embodiments transmit to the UE 120, a message comprising an indication indicating that the mode of operation associated to the SCG is changed to the preferred mode of operation associated to the SCG determined by the UE 120.

As mentioned above, the indication may indicate any one or more out of: The SCG has been added, the SCG has been released, the SCG has been activated, the SCG has been deactivated, the SCG has been changed e.g., from a previously added SCG, suspending an RRC connection and releasing the RRC connection.

When indicating any one or more out of: Adding, releasing, activating, deactivating or changing the SCG, the indication may be comprised in e.g., an RRC reconfiguration message.

When indicating suspending the SCG the indication may be comprised in e.g., an RRC release message comprising a suspendConfig configuration indication to suspend the SCG.

When indicating releasing the SCG the indication may be comprised in e.g., an RRC release message.

When indicating adding the SCG, the indication may further indicate e.g., to add the SCG, to setup MR-DC or both.

When indicating releasing the SCG, the indication may further indicate e.g., to release the SCG, to release MR-DC or both.

When indicating activating the SCG, the indication may further indicate e.g., to activate the SCG.

When indicating deactivating the SCG, the indication may further indicate e.g., to deactivate the SCG.

When indicating changing the SCG, the indication may further indicate e.g., to change the SCG.

The method will now be further explained and exemplified in below example embodiments. These below example embodiments may be combined with any suitable embodiment as described above. In these example embodiments, the UE 120 is in some places referred to as UE and the network node 110 is in some places referred to as network or network node.

### Example Embodiment A

The UE, such as e.g., the UE 120, may be configured to provide UE assistance information to the network, such as e.g., the network node 110, concerning SCG mode of operation, such as e.g., the preferred mode of operation associated to the SCG. Such assistance information may comprise any of the following:
1. An Indication of UE preference to have the SCG activated.
   This may be further used to change previous preferences of the UE, such as e.g., the UE 120, e.g., if the UE, such as e.g., the UE 120, previously indicated that it would prefer to have the SCG deactivated.
   A UE, such as e.g., the UE 120, configured with MR-DC may determine that it wants to activate the SCG, e.g., based on early indications in the UE, such as e.g., the UE 120, e.g., that a certain application is started, that certain measurements are to be sent, based on UE mobility or based on traffic conditions, data volume calculation, type of traffic requiring of SCG to be active, etc.
2. An Indication of UE preference to have the SCG deactivated.
   The UE, such as e.g., the UE 120, may indicate a preference to not keep the SCG activated. The main difference in this case is that the network does not interpret the UE report as meaning necessarily that the UE, such as e.g., the UE 120, would prefer the SCG to be deactivated, it would rather mean that the SCG activated state is not preferred. That implies that the UE, such as e.g., the UE 120, may not have a particular preference on whether the SCG is deactivated, released or reconfigured.
   In one embodiment, the UE, such as e.g., the UE 120, configured with MR-DC determines that it wants to deactivate the SCG, e.g., based on traffic conditions, data volume calculation, type of traffic requiring of not SCG to be active, etc. Then, the UE, such as e.g., the UE 120, triggers a UE Assistance Information procedure and transmits to the network, such as the network node 110, e.g., via the MCG, an indication of whether it wants the SCG to be released or inactivated. That may be determined based on the UE mobility, e.g., the UE, such as e.g., the UE 120, may indicate that it wants to release the SCG if it is in high mobility and/or the time it expects to be without data transmissions is above a threshold. The UE, such as e.g., the UE 120, may indicate that it wants to inactivate the SCG if it is in low or moderated mobility and/or the time it expects to be without data transmissions is below a threshold.
3. An Indication of UE preference to have an SCG added.
4. An Indication of UE preference to have the SCG released.
5. A UE assistance information message that does no longer include an indication of UE preference for a certain SCG mode of operation, such as e.g., the preferred mode of operation associated to the SCG. As an example, if the UE, such as e.g., the UE 120, has sent a UE assistance information message to the network with an indication of UE preference to have the SCG released, the transmission of a new UE assistance information message where this indication, of UE preference to have the SCG released, is not present, corresponds to a UE preference, such as e.g., the preferred mode of operation associated to the SCG, to have the SCG added again. There may also be an explicit indication from the UE with a preference to keep the SCG.
6. Cause values to inform the network, such as e.g., the network node 110, why the procedure was triggered, which may include values such as:
   Pending data to be sent through the UL SCG. This may be useful e.g., when the UE, such as e.g., the UE 120, indicates a preference to have the SCG activated (1) and may thus further include a cause value to inform that such preference is due to pending data to be sent.
   SCG deactivation, release, or downgrade. This may be useful e.g., when the UE, such as e.g., the UE 120, indicates a preference to have the SCG deactivated (2) and can thus further include a cause value to inform that such preference is due to a preference to deactivate, release or downgrade the SCG. In case the preference concern downgrade the SCG configuration, the UE, such as e.g., the UE 120, may provide further information on which aspects it has a preference to be downgraded.
7. A mode of operation associated in MN or SN format:
   In one embodiment, the preferred mode of operation associated to the SCG is encoded in SN format. One of the purposes may be to enable the SN to decode the preferred mode of operation associated to a the SCG, e.g., in case the procedure is SN initiated. In one option, the preferred mode of operation associated to the SCG is encoded as an RRC parameter, or message such as an RRCReconfiguration container, in the format of the SN's RRC. If the SN is an NR node, such as a gNodeB, e.g., for a UE, such as e.g., the UE 120, in EN-DC or NR-DC, the preferred mode of operation associated to the SCG is encoded in NR RRC format. If the SN is an EUTRA/LTE node, such as an eNodeB, e.g., for a UE, such as e.g., the UE 120, in NE-DC, the preferred mode of operation associated to the SCG is encoded in EUTRA/LTE RRC format. In one option, the preferred mode of operation associated to the SCG is transmitted to the MN in a message in MN format so that the MN is able to receive it, such as an ULInformationTransferMRDC, possibly including an ul-DCCH-MessageNR as an OCTET STRING or an ul-DCCH-MessageEUTRA as an OCTET STRING. The transmission via MN may depend on if SRB3 is configured or not, or in case the SCG is deactivated, SRB1 is always used.
   An example of how this may be implemented in the RRC specs is shown below:

ULInformationTransferMRDC field descriptions

ul-DCCH-MessageNR
Includes the UL-DCCH-Message. In this version of the specification,
the field is only used to transfer the NR RRC MeasurementReport,
RRCReconfigurationComplete, UEAssistanceInformation and
FailureInformation messages when sent via SRB1 and to transfer the
NR MCGFailureInformation message when sent via SRB3.
ul-DCCH-MessageEUTRA
Includes the UL-DCCH-Message. In this version of the specification,
the field is only used to transfer the E-UTRA RRC MeasurementReport
message when sent via SRB1 and to transfer the E-UTRA
MCGFailureInformation message when sent via SRB3.

In another embodiment, the preferred mode of operation associated to the SCG is encoded in MN format. One of the purposes may be to enable the MN to decode the preferred mode of operation associated to the SCG, e.g., in case the procedure is MN initiated. In one option, that is encoded as an RRC parameter, or message, such as an RRCReconfiguration container, in the format of the MN's RRC. If the MN is an NR node, such as a gNodeB, e.g., for a UE, such as e.g., the UE 120, in NE-DC or NR-DC, the preferred mode of operation associated to the SCG is encoded in NR RRC format. If the MN is an EUTRA/LTE node, such as an eNodeB, e.g., for a UE, such as e.g., the UE 120, in NE-DC, the preferred mode of operation associated to the SCG is encoded in EUTRA/LTE RRC format. In one option, the preferred mode of operation associated to the SCG is transmitted to the MN in a message in MN format so that the MN is able to receive it, such as the UEAssistanceInformation message.
In another embodiment, the UE, such as e.g., the UE 120, determines to encode the preferred mode of operation associated to the SCG in MN format or SN format depending on network configuration. For example, if the MN configures the UE to report the preferred mode of operation associated to the SCG, as an MN/MCG configuration, the UE, such as e.g., the UE 120, encodes the preferred mode of operation associated to the SCG in MN format. If the SN configures the UE, such as e.g., the UE 120, to report the preferred mode of operation associated to the SCG, as an SN/SCG configuration, the UE, such as e.g., the UE 120, encodes the preferred mode of operation associated to the SCG in SN format. Or, regardless of which node, the MN or SN, configures the report of the preferred mode of operation associated to the SCG, it includes a configuration indicating in which format the UE, such as e.g., the UE 120, shall report the preferred mode of operation associated to the SCG.
In another embodiment, the UE, such as e.g., the UE 120, determines to encode the preferred mode of operation associated to the SCG in MN format or SN format depending on a rule. For example, a rule may be a function on the type of traffic and/or related data volume that is used by the UE, such as e.g., the UE 120, to determine the preferred mode of operation associated to the SCG. For example, if the traffic that is to be deactivated comes from an SCG or SN terminated bearer, the UE, such as e.g., the UE 120, encodes it in SN format, as it expects the deactivation to be triggered by the SN. Or if the traffic that is to be deactivated comes from an MCG or MN terminated bearer, the UE, such as e.g., the UE 120, encodes it in MN format, as it expects the deactivation to be triggered by the MN.
8. A UE assistance information message which comprises the preferred mode of operation associated to the SCG as part of overheating indication or UE power saving preferences.

### Example Embodiment B

The UE, such as e.g., the UE 120, may be configured to provide UE assistance information to the network concerning SCG mode of operation, such as e.g., a preferred mode of operation associated with the SCG. Such assistance information may be triggered, or prevented to be triggered, by any of following:
1. A timer to prohibit frequent reports sent by the UE, such as e.g., the UE 120, e.g., the UE, such as e.g., the UE 120, may only send another report once the timer expires.
2. Providing different information as a condition to send a subsequent report, e.g., if the UE, such as e.g., the UE 120, has already sent a report concerning SCG activation or deactivation, the UE, such as e.g., the UE 120, may only send another report if it concerns different information, such as e.g., a preferred mode of operation associated with the SCG, compared to the previous report.
3. Providing an indication if the current SCG state is different from the preference of the UE, such as e.g., the UE 120. E.g., the UE, such as e.g., the UE 120, may only send the report if 1) the UE, such as e.g., the UE 120, prefers SCG to be “deactivated” and the SCG state is “activated”; or 2) the UE, such as e.g., the UE 120, prefers SCG to be “activated” and the SCG state is “deactivated”. This approach gives the flexibility to the network, such as e.g., the network node 110, to activate SCG without UE assistance information, such as DL traffic. For example, after the UE indicates that it prefers “deactivated”, the network, such as e.g., the network node 110, may go through the steps of “activate”->“deactivate”->“activate”. After this, if the UE, such as e.g., the UE 120, still prefers the SCG state to be “deactivated”, the UE, such as e.g., the UE 120, may send the report one more time.
4. A Report based on cause value. E.g., the UE, such as e.g., the UE 120, may only send a report concerning SCG mode of operation, such as e.g., a preferred mode of operation associated with the SCG, if the report is triggered by specific cause values as described in example embodiment A.6.
5. Network, such as e.g., the network node 110, configured conditions, which may e.g., include any of the other conditions listed here.
6. During a handover, e.g., right after the handover (reconfiguration with synchronisation) to a target cell, the UE, such as e.g., the UE 120, may indicate the preference of the SCG mode of operation, such as e.g., a preferred mode of operation associated with the SCG, to the target cell. That may be optionally done in case the target node has not set the SCG to deactivated mode of operation, but the UE, such as e.g., the UE 120, determines, e.g., based on its data traffic demands, that it prefers the SCG to be deactivated.
7. During a reconfiguration procedure other than handover.
8. During a connection setup, e.g., after security is established.
9. During a re-establishment procedure.
10. During a resume procedure.
11. Before the UE, such as e.g., the UE 120, is suspended, such as e.g., before a suspend procedure.
   a. In one example, the UE, such as e.g., the UE 120, may include in the same message an indication that it wants the connection to be suspended and, in addition, that it wants the SCG to be suspended e.g., in case the UE, such as e.g., the UE 120, expects a traffic demand that would benefit from MR-DC, so that the suspended SCG may be resumed and/or in case the UE, such as e.g., the UE 120, expects to be static or semi-static so that most, or a significant part, of the SCG configuration remains the same, and may efficiently be resumed. In response to that preference report, such as e.g., a preferred mode of operation associated with the SCG, the network, such as e.g., the network node 110, may suspend the UE, such as e.g., the UE 120, and request the UE, such as e.g., the UE 120, to keep the SCG stored, e.g., by not releasing the SCG before it suspends it.
   b. In another example, the UE, such as e.g., the UE 120, may include in the same message an indication that it wants the connection to be suspended and, in addition, that it wants the SCG to be released e.g., in case the UE, such as e.g., the UE 120, expects a traffic demand that would not benefit so much from MR-DC and/or in case the UE expects to move so that the PSCell and/or SCG SCells would need to be changed upon resume. In response to that preference report. such as e.g., a preferred mode of operation associated with the SCG, the network, such as e.g., the network node 110, may release MR-DC at the UE, such as e.g., the UE 120, e.g., by transmitting an RRC Reconfiguration message releasing the SCG before it suspends the UE, such as e.g., the UE 120, with an RRC Release message with a suspend configuration.
12. For a UE, such as e.g., the UE 120, that is configured to provide assistance information on SCG activation, such as e.g., a preferred mode of operation associated with the SCG, when the UE, such as e.g., the UE 120, initiates RRC connection re-establishment procedure or when the UE 120 initiates a RRC resume procedure, the configuration related with assistance information on SCG activation is released by the UE, such as e.g., the UE 120.
13. An indication of UE preference, such as e.g., a preferred mode of operation associated with the SCG, to have an SCG added to the UE configuration.
   a. In one alternative, this UE preference to add an SCG, such as e.g., a preferred mode of operation associated with the SCG, is triggered by a UE, such as e.g., the UE 120, with no SCG configured, e.g., a UE, such as e.g., the UE 120, that only has an MCG configured, thus indicating a preference to add at least one SCG. In another alternative, the UE preference to add an SCG, such as e.g., a preferred mode of operation associated with the SCG, is triggered by a UE, such as e.g., the UE 120, that already has an SCG configured, thus indicating an additional Cell Group, e.g., to indicate a preference for more Cell Groups than the MCG and the (first) SCG.
   14. If sending a UE assistance information message that does no longer include an indication of UE preference for a certain SCG mode of operation, such as e.g., a preferred mode of operation associated with the SCG. As an example, if the UE, such as e.g., the UE 120, has sent a UE assistance information message, such as e.g., a preferred mode of operation associated with the SCG, to the network, such as e.g., the network node 110, with an indication of UE preference to have the SCG released, the transmission of a new UE assistance information message, such as e.g., a preferred mode of operation associated with the SCG, where this indication, of UE preference to have the SCG released, is not present corresponds to a UE preference to have the SCG added again. There may also be an explicit indication from the UE, such as e.g., the UE 120, with a preference to keep the SCG.

### Example Embodiment C

A network node, such as e.g., the network node 110, may configure the UE, such as e.g., the UE 120, to provide UE assistance information to the network, such as e.g., the network node 110, concerning SCG mode of operation, such as e.g., a preferred mode of operation associated with the SCG. The network node, such as e.g., network node 110, may decide to configure the UE, such as e.g., the UE 120, to provide such information based on any of the following:
1. Based on deployment option, e.g., for some cases it may be sufficient that either the MN or SN configures the UE, such as e.g., the UE 120, to provide UE assistance information, but not both. In other cases the UE, such as e.g., the UE 120, may also be configured to provide UE assistance information to both the MN and the SN.
2. An MN, such as e.g., the network node 110, may decide to configure the UE, such as e.g., the UE 120, with this mechanism, e.g., once it receives an indication from the SN, such as e.g., the network node 110, to activate or deactivate the SCG.
3. An SN, such as e.g., the network node 110, may decide to configure the UE, such as e.g., the UE 120, with this mechanism, e.g., once it receives an indication from the MN, such as e.g., the network node 110, to activate or deactivate the SCG.

### Example Embodiment D

A network node, such as e.g., the network node 110, may configure the UE, such as e.g., the UE 120, to provide UE assistance information to the network, such as e.g., the network node 110, concerning SCG mode of operation, such as e.g., a preferred mode of operation associated with the SCG. Based on the reception of such report from the UE, such as e.g., the UE 120, the network node, such as e.g., the network node 110, may take any of the following actions:
1. Forward this UE report to another node, e.g., from an MN, such as e.g., the network node 110, to an SN or from an SN, such as e.g., the network node 110, to an MN, such as e.g., the network node 110.
2. Indicate to another node specific information from the UE report, e.g., the MN, such as e.g., the network node 110, may have received a UE preference to deactivate the SCG together, such as e.g., a preferred mode of operation associated with the SCG, with a cause value, and additional fields, the MN, such as e.g., the network node 110, may then decide to ultimately just indicate to the SN that the SCG should be deactivated. The roles of the MN and the SN may be switched, in which case the SN, such as e.g., the network node 110, performs the actions of the MN and the MN performs the actions of the SN, such as e.g., the network node 110.
3. Generate its own assistance information report to be sent to another node, e.g., the MN, such as e.g., the network node 110, may forward the received UE report, such as e.g., a preferred mode of operation associated with the SCG, but additionally include MN generated information that may be relevant for the SN in case of SCG activation or deactivation. The roles of the MN and the SN may be switched, in which case the SN, such as e.g., the network node 110, performs the actions of the MN and the MN performs the actions of the SN, such as e.g., the network node 110.
4. Take own actions and reconfigure the UE, such as e.g., the UE 120, e.g., activate or deactivate the SCG depending on the assistance information, such as e.g., a preferred mode of operation associated with the SCG, provided by the UE, such as e.g., the UE 120.
5. Attend the UE, such as e.g., the UE 120, request, e.g., reconfigure the UE, such as e.g., the UE 120, based on the received UE assistance information, such as e.g., a preferred mode of operation associated with the SCG.

Examples for 3GPP TS 38.331 on the example embodiments above are described in the following subsections. A similar approach may be adopted in 3GPP TS 36.331.

### Example Embodiments A and B

Examples for the UE, such as the UE 120, aspects are detailed below.

### 3GPP TS 38.331 6.3.2 Radio Resource Control Information Elements

### UEAssistanceInformation

The UEAssistanceInformation message is used for the indication of UE assistance information to the network.
Signalling radio bearer: SRB1, SRB3
RLC-SAP: AM
Logical channel: DCCH
Direction: UE to Network
UEAssistanceInformation message

-- ASN1START
-- TAG-UEASSISTANCEINFORMATION-START

| UEAssistanceInformation ::= | SEQUENCE { | |
|---|---|---|
| criticalExtensions | CHOICE { | |
| ueAssistanceInformation | UEAssistanceInformation-IEs, | |
| criticalExtensionsFuture | SEQUENCE { } | |
| } | | |
| } | | |
| UEAssistanceInformation-IEs ::= | SEQUENCE { | |
| delayBudgetReport | DelayBudgetReport | OPTIONAL, |
| lateNonCriticalExtension | OCTET STRING | OPTIONAL, |
| nonCriticalExtension | UEAssistanceInformation-v1540-IEs | OPTIONAL |
| } | | |
| UEAssistanceInformation-v1610-IEs ::= SEQUENCE { | | |
| idc-Assistance-r16 | IDC-Assistance-r16 | OPTIONAL, |
| drx-Preference-r16 | DRX-Preference-r16 | OPTIONAL, |
| maxBW-Preference-r16 | MaxBW-Preference-r16 | OPTIONAL, |
| maxCC-Preference-r16 | MaxCC-Preference-r16 | OPTIONAL, |
| maxMIMO-LayerPreference-r16 | MaxMIMO-LayerPreference-r16 | OPTIONAL, |
| minSchedulingOffsetPreference-r16 | MinSchedulingOffsetPreference-r16 | OPTIONAL, |
| releasePreference-r16 | ReleasePreference-r16 | OPTIONAL, |
| sl-UE-AssistanceInformationNR-r16 | SL-UE-AssistanceInformationNR-r16 | OPTIONAL, |
| referenceTimeInfoPreference-r16 | BOOLEAN | OPTIONAL, |
| nonCriticalExtension | UEAssistanceInformation-v17xy-IEs | OPTIONAL |
| } | | |
| UEAssistanceInformation-v17xy-IEs ::= SEQUENCE { | | |
| scg-Preference-r17 | SCG-Preference-r17 | OPTIONAL, |
| nonCriticalExtension | SEQUENCE { } | OPTIONAL |
| } | | |
| SCG-Preference-r17 ::= | SEQUENCE { | |

| | |
|---|---|
| scg-State | ENUMERATED {activated, notActivated, release, releaseSCG}, |

| | |
|---|---|
| additionInfo | AdditionInfo, |

. . .
}

| | |
|---|---|
| AdditionInfo ::= | ENUMERATED { |

| | ul-Data, |
|---|---|
| | overheating, outputPower, batteryLevel, lowLatenyData, spare2, spare1} |
| -- TAG-UEASSISTANCEINFORMATION-STOP | |
| -- ASN1STOP | |

UEAssistanceInformation field descriptions

scgPreference
Indicates the UE's preferences on SCG activation.

### 3GPP TS 38.331 5.7.4.2 Initiation

A UE capable of providing its preference on SCG activation may initiate the procedure in several cases, if it was configured to do so, including upon having a preference on SCG activation and upon change of its SCG activation preference.

Upon initiating the procedure, the UE shall:
******omitted unchanged parts*********
1> if configured to provide its preference on SCG activation:
   2> if the UE has a preference on SCG activation parameters and the UE did not transmit a UEAssistanceInformation message with scg-Preference since it was configured with SCG as activated or deactivated; or
   2> if the current scg-Preference information includes a different scg-State from the one indicated in the last transmission of the UEAssistanceInformation message including scg-Preference and timer T3xy is not running:
      3> start the timer T3xy with the timer value set to the scg-PreferenceProhibitTimer,
      3> initiate transmission of the UEAssistanceInformation message in accordance with 5.7.4.3 to provide the current scg-Preference;

### 3GPP TS 38.331 5.7.4.3 Actions Related to Transmission of UEAssistanceInformation Message

The UE shall set the contents of the UEAssistanceInformation message as follows:
******omitted unchanged parts*********
1> if transmission of the UEAssistanceInformation message is initiated to provide scg-Preference according to 5.7.4.2;
   2> set scg-State to the its preferred value;
   2> set assitanceCause to the its preferred value;

The UE shall:
1> if the procedure was triggered to provide configured grant assistance information for NR sidelink communication by an NR RRCReconfiguration message that was embedded within an E-UTRA RRCConnectionReconfiguration:
   2> submit the UEAssistanceInformation to lower layers via SRB1, embedded in E-UTRA RRC message ULInformation TransferIRAT as specified in TS 36.331 [10], clause 5.6.28;
1> else if the UE is in (NG)EN-DC:
   2> if SRB3 is configured:
      3> submit the UEAssistanceInformation message via SRB3 to lower layers for transmission;
   2> else:
      3> submit the UEAssistanceInformation message via the E-UTRA MCG embedded in E-UTRA RRC message ULInformation TransferMRDC as specified in TS 36.331 [10].
1> else if the UE is in NR-DC:
   2> if the UE assistance configuration that triggered this UE assistance information is associated with the SCG:
      3> if SRB3 is configured:
         4> submit the UEAssistanceInformation message via SRB3 to lower layers for transmission;
      3> else:
         4> submit the UEAssistanceInformation message via the NR MCG embedded in NR RRC message ULInformationTransferMRDC as specified in 5.7.2a.3;
   2> else:
      3> submit the UEAssistanceInformation message via SRB1 to lower layers for transmission;
1> else:
   2> submit the UEAssistanceInformation message to lower layers for transmission

### 3GPP TS 38.331 6.3.4 Other Information Elements

### OtherConfig

The IE OtherConfig contains configuration related to miscellaneous other configurations. OtherConfig information element

-- ASN1START

| -- TAG-OTHERCONFIG-START | | |
|---|---|---|
| OtherConfig-v1610 ::= | SEQUENCE { | OPTIONAL, -- Need M |

| | | |
|---|---|---|
| idc-AssistanceConfig-r16 | SetupRelease {IDC-AssistanceConfig-r16} | OPTIONAL, -- Need M |
| drx-PreferenceConfig-r16 | SetupRelease {DRX-PreferenceConfig-r16} | OPTIONAL, -- Need M |
| maxBW-PreferenceConfig-r16 | SetupRelease {MaxBW-PreferenceConfig-r16} | OPTIONAL, -- Need M |
| maxCC-PreferenceConfig-r16 | SetupRelease {MaxCC-PreferenceConfig-r16} | OPTIONAL, -- Need M |
| maxMIMO-LayerPreferenceConfig-r16 | SetupRelease {MaxMIMO-LayerPreferenceConfig-r16} | OPTIONAL, -- Need M |
| minSchedulingOffsetPreferenceConfig-r16 | SetupRelease {MinSchedulingOffsetPreferenceConfig-r16} | OPTIONAL, -- Need M |
| releasePreferenceConfig-r16 | SetupRelease {ReleasePreferenceConfig-r16} | OPTIONAL, -- Need M |
| referenceTimePreferenceReporting-r16 | ENUMERATED {true} | OPTIONAL, -- Need R |
| btNameList-r16 | SetupRelease {BT-NameList-r16} | OPTIONAL, -- Need M |
| wlanNameList-r16 | SetupRelease {WLAN-NameList-r16} | OPTIONAL, -- Need M |
| sensorNameList-r16 | SetupRelease {Sensor-NameList-r16} | OPTIONAL, -- Need M |
| obtainCommonLocation-r16 | ENUMERATED {true} | OPTIONAL, -- Need R |
| sl-AssistanceConfigNR-r16 | ENUMERATED{true} | OPTIONAL -- Need R |

| } | |
|---|---|
| OverheatingAssistanceConfig ::= SEQUENCE { | |
| overheatingIndicationProhibitTimer | ENUMERATED {s0, s0dot5, s1, s2, s5, s10, s20, s30, |
| | s60, s90, s120, s300, s600, spare3, spare2, spare1} |

}

IDC-AssistanceConfig-r16 ::= SEQUENCE {

| | |
|---|---|
| candidateServingFreqListNR-r16 CandidateServingFreqListNR-r16 | OPTIONAL, -- Need R |

. . .
}

| | |
|---|---|
| DRX-PreferenceConfig-r16 ::= | SEQUENCE { |

| | |
|---|---|
| drx-PreferenceProhibitTimer-r16 | ENUMERATED { |

| | |
|---|---|
| | s0, s0dot5, s1, s2, s3, s4, s5, s6, s7, |
| | s8, s9, s10, s30, spare2, spare1} |
| } | |

| | |
|---|---|
| MaxBW-PreferenceConfig-r16 ::= | SEQUENCE { |

| | |
|---|---|
| maxBW-PreferenceProhibitTimer-r16 | ENUMERATED { |

| | |
|---|---|
| | s0, s0dot5, s1, s2, s3, s4, s5, s6, s7, |
| | s8, s9, s10, s30, spare2, spare1} |
| } | |

| | |
|---|---|
| MaxCC-PreferenceConfig-r16 ::= | SEQUENCE { |

| | |
|---|---|
| maxCC-PreferenceProhibitTimer-r16 | ENUMERATED { |

| | |
|---|---|
| | s0, s0dot5, s1, s2, s3, s4, s5, s6, s7, |
| | s8, s9, s10, s30, spare2, spare1} |
| } | |

| | |
|---|---|
| MaxMIMO-LayerPreferenceConfig-r16 ::= | SEQUENCE { |

| maxMIMO-LayerPreferenceProhibitTimer-r16 ENUMERATED { | |
|---|---|
| | s0, s0dot5, s1, s2, s3, s4, s5, s6, s7, |
| | s8, s9, s10, s30, spare2, spare1} |
| } | |
| MinSchedulingOffsetPreferenceConfig-r16 ::= SEQUENCE { | |
| minSchedulingOffsetPreferenceProhibitTimer-r16 ENUMERATED { | |
| | s0, s0dot5, s1, s2, s3, s4, s5, s6, s7, |
| | s8, s9, s10, s30, spare2, spare1} |
| } | |

| | |
|---|---|
| ReleasePreferenceConfig-r16 ::= | SEQUENCE { |

| | |
|---|---|
| releasePreferenceProhibitTimer-r16 | ENUMERATED { |

```
  s0, s0dot5, s1, s2, s3, s4, s5, s6, s7,
  s8, s9, s10, s30, spare2, spare1}
```

| | | |
|---|---|---|
| connectedReporting | ENUMERATED {true} | OPTIONAL, -- Need R |

}

| | |
|---|---|
| OtherConfig-v17xy ::= | SEQUENCE { |

| | | |
|---|---|---|
| scg-AssistanceConfig-r17 | SetupRelease {SCG-AssistanceConfig-r17} | OPTIONAL, -- Need M |
| } | | |

| | |
|---|---|
| SCG-AssistanceConfig-r17 ::= | SEQUENCE { |
| scg-PreferenceProhibitTimer | ENUMERATED { |

```
  s0, s0dot5, s1, s2, s3, s4, s5, s6, s7,
  s8, s9, s10, s30, spare2, spare1}
```

}

-- TAG-OTHERCONFIG-STOP
-- ASN1STOP

### 3GPP TS 38.331 5.3.7.2 Initiation

The UE initiates the procedure when one of the following conditions is met:
1> upon detecting radio link failure of the MCG and t316 is not configured, in accordance with 5.3.10; or
1> upon detecting radio link failure of the MCG while SCG transmission is suspended, in accordance with 5.3.10; or
1> upon detecting radio link failure of the MCG while PSCell change is ongoing, in accordance with 5.3.10; or
1> upon re-configuration with sync failure of the MCG, in accordance with sub-clause 5.3.5.8.3; or
1> upon mobility from NR failure, in accordance with sub-clause 5.4.3.5; or
1> upon integrity check failure indication from lower layers concerning SRB1 or SRB2, except if the integrity check failure is detected on the RRCReestablishment message; or
1> upon an RRC connection reconfiguration failure, in accordance with sub-clause 5.3.5.8.2; or
1> upon detecting radio link failure for the SCG while MCG transmission is suspended, in accordance with subclause 5.3.10.3 in NR-DC or in accordance with TS 36.331 subclause 5.3.11.3 in NE-DC; or
1> upon reconfiguration with sync failure of the SCG while MCG transmission is suspended in accordance with subclause 5.3.5.8.3; or
1> upon SCG change failure while MCG transmission is suspended in accordance with TS 36.331 subclause 5.3.5.7a; or
1> upon SCG configuration failure while MCG transmission is suspended in accordance with subclause 5.3.5.8.2 in NR-DC or in accordance with TS 36.331 [10] subclause 5.3.5.5 in NE-DC; or
1> upon integrity check failure indication from SCG lower layers concerning SRB3 while MCG is suspended; or
1> upon T316 expiry, in accordance with sub-clause 5.7.3b.5.

Upon initiation of the procedure, the UE shall:
1> stop timer T310, if running;
1> stop timer T312, if running;
1> stop timer T304, if running;
1> start timer T311;
1> stop timer T316, if running;
1> if UE is not configured with conditionalReconfiguration:
   2> reset MAC;
   2> release spCellConfig, if configured;
   2> suspend all RBs, except SRB0;
   2> release the MCG SCell(s), if configured;
   2> if MR-DC is configured:
      3> perform MR-DC release, as specified in clause 5.3.5.10;
   2> release delayBudgetReportingConfig, if configured and stop timer T342, if running;
   2> release overheatingAssistanceConfig, if configured and stop timer T345, if running;
   2> release idc-AssistanceConfig, if configured;
   2> release btNameList, if configured;
   2> release wlanNameList, if configured;
   2> release sensorNameList, if configured;
   2> release drx-PreferenceConfig for the MCG, if configured and stop timer T346a associated with the MCG, if running;
   2> release maxBW-PreferenceConfig for the MCG, if configured and stop timer T346b associated with the MCG, if running;
   2> release maxCC-PreferenceConfig for the MCG, if configured and stop timer T346c associated with the MCG, if running;
   2> release maxMIMO-LayerPreferenceConfig for the MCG, if configured and stop timer T346d associated with the MCG, if running;
   2> release minSchedulingOffsetPreferenceConfig for the MCG, if configured stop timer T346e associated with the MCG, if running;
   2> release releasePreferenceConfig, if configured stop timer T346f, if running;
   2> release onDemandSIB-Request if configured, and stop timer T350, if running;
   2> release reference TimePreferenceReporting, if configured;
   2> release obtainCommonLocation, if configured;
   2> release sl-AssistanceConfigNR, if configured;
   2> release scg-AssistanceConfig, if configured.

### 3GPP TS 38.331 5.3.13.2 Initiation

The UE initiates the procedure when upper layers or AS (when responding to RAN paging, upon triggering RNA updates while the UE is in RRC_INACTIVE, or for sidelink communication as specified in sub-clause 5.3.13.1a) requests the resume of a suspended RRC connection.

The UE shall ensure having valid and up to date essential system information as specified in clause 5.2.2.2 before initiating this procedure.

Upon initiation of the procedure, the UE shall:
1> if the resumption of the RRC connection is triggered by response to NG-RAN paging:
   2> select ‘0’ as the Access Category;
   2> perform the unified access control procedure as specified in 5.3.14 using the selected Access Category and one or more Access Identities provided by upper layers;
      3> if the access attempt is barred, the procedure ends;
1> else if the resumption of the RRC connection is triggered by upper layers:
   2> if the upper layers provide an Access Category and one or more Access Identities:
      3> perform the unified access control procedure as specified in 5.3.14 using the Access Category and Access Identities provided by upper layers;
         4> if the access attempt is barred, the procedure ends;
   2> set the resumeCause in accordance with the information received from upper layers;
1> else if the resumption of the RRC connection is triggered due to an RNA update as specified in 5.3.13.8:
   2> if an emergency service is ongoing:
   NOTE: How the RRC layer in the UE is aware of an ongoing emergency service is up to UE implementation.
      3> select ‘2’ as the Access Category;
      3> set the resumeCause to emergency,
   2> else:
      3> select ‘8’ as the Access Category;
   2> perform the unified access control procedure as specified in 5.3.14 using the selected Access Category and one or more Access Identities to be applied as specified in TS 24.501 [23];
      3> if the access attempt is barred:
         4> set the variable pendingRNA-Update to true;
         4> the procedure ends;
1> if the UE is in NE-DC or NR-DC:
   2> if the UE does not support maintaining SCG configuration upon connection resumption:
      3> release the MR-DC related configurations (i.e., as specified in 5.3.5.10) from the UE Inactive AS context, if stored;
1> if the UE does not support maintaining the MCG SCell configurations upon connection resumption:
   2> release the MCG SCell(s) from the UE Inactive AS context, if stored;
1> apply the default L1 parameter values as specified in corresponding physical layer specifications, except for the parameters for which values are provided in SIB1;
1> apply the default SRB1 configuration as specified in 9.2.1;
1> apply the default MAC Cell Group configuration as specified in 9.2.2;
1> release delayBudgetReportingConfig from the UE Inactive AS context, if stored;
1> stop timer T342, if running;
1> release overheatingAssistanceConfig from the UE Inactive AS context, if stored;
1> stop timer T345, if running;
1> release idc-AssistanceConfig from the UE Inactive AS context, if stored;
1> release drx-PreferenceConfig for all configured cell groups from the UE Inactive AS context, if stored;
1> stop all instances of timer T346a, if running;
1> release maxBW-PreferenceConfig for all configured cell groups from the UE Inactive AS context, if stored;
1> stop all instances of timer T346b, if running;
1> release maxCC-PreferenceConfig for all configured cell groups from the UE Inactive AS context, if stored;
1> stop all instances of timer T346c, if running;
1> release maxMIMO-LayerPreferenceConfig for all configured cell groups from the UE Inactive AS context, if stored;
1> stop all instances of timer T346d, if running;
1> release minSchedulingOffsetPreferenceConfig for all configured cell groups from the UE Inactive AS context, if stored;
1> stop all instances of timer T346e, if running;
1> release releasePreferenceConfig from the UE Inactive AS context, if stored;
1> release reference TimePreferenceReporting from the UE Inactive AS context, if stored;
1> release btNameList from the UE Inactive AS context, if stored;
1> release wlanNameList from the UE Inactive AS context, if stored;
1> release sensorNameList from the UE Inactive AS context, if stored;
1> release obtainCommonLocation from the UE Inactive AS context, if stored;
1> release sl-AssistanceConfigNR from the UE Inactive AS context, if stored;
1> release scg-AssistanceConfig from the UE Inactive AS context, if stored.
1> stop timer T346f, if running;
1> apply the CCCH configuration as specified in 9.1.1.2;
1> apply the timeAlignmentTimerCommon included in SIB1;
1> start timer T319;
1> set the variable pendingRNA-Update to false;
1> initiate transmission of the RRCResumeRequest message or RRCResumeRequest1 in accordance with 5.3.13.3.

Example for the case when the UE assistance information message which contains the preferred mode of operation associated to the SCG as part of overheating indication.

### 3GPP TS 38.331 5.7.4.3a Setting the Contents of OverheatingAssistance IE

The UE shall set the contents of OverheatingAssistance IE if initiated to provide overheating assistance indication for SCG in (NG)EN-DC according to clause 5.6.10.3 as specified in TS 36.331 [10]:
1> if the UE prefers to temporarily reduce the number of maximum secondary component carriers for SCG:
   2> include reducedMaxCCs in the OverheatingAssistance IE;
   2> set reducedCCsDL to the number of maximum SCells of the SCG the UE prefers to be temporarily configured in downlink;
   2> set reducedCCsUL to the number of maximum SCells of the SCG the UE prefers to be temporarily configured in uplink;
1> if the UE prefers to temporarily reduce maximum aggregated bandwidth of FR1 for SCG:
   2> include reducedMaxBW-FR1 in the OverheatingAssistance IE;
   2> set reducedBW-FR1-DL to the maximum aggregated bandwidth the UE prefers to be temporarily configured across all downlink carriers of FR1 of the SCG;
   2> set reducedBW-FR1-UL to the maximum aggregated bandwidth the UE prefers to be temporarily configured across all uplink carriers of FR1 of the SCG;
1> if the UE prefers to temporarily reduce maximum aggregated bandwidth of FR2 for SCG:
   2> include reducedMaxBW-FR2 in the OverheatingAssistance IE;
   2> set reducedBW-FR2-DL to the maximum aggregated bandwidth the UE prefers to be temporarily configured across all downlink carriers of FR2 of the SCG;
   2> set reducedBW-FR2-UL to the maximum aggregated bandwidth the UE prefers to be temporarily configured across all uplink carriers of FR2 of the SCG;
1> if the UE prefers to temporarily reduce the number of maximum MIMO layers of each serving cell operating on FR1 for SCG:
   2> include reducedMaxMIMO-LayersFR1 in the OverheatingAssistance IE;
   2> set reducedMIMO-LayersFR1-DL to the number of maximum MIMO layers of each serving cell operating on FR1 of the SCG the UE prefers to be temporarily configured in downlink;
   2> set reducedMIMO-LayersFR1-UL to the number of maximum MIMO layers of each serving cell operating on FR1 of the SCG the UE prefers to be temporarily configured in uplink;
1> if the UE prefers to temporarily reduce the number of maximum MIMO layers of each serving cell operating on FR2 for SCG:
   2> include reducedMaxMIMO-LayersFR2 in the Overheating Assistance IE;
   2> set reducedMIMO-LayersFR2-DL to the number of maximum MIMO layers of each serving cell operating on FR2 of the SCG the UE prefers to be temporarily configured in downlink;
   2> set reducedMIMO-LayersFR2-UL to the number of maximum MIMO layers of each serving cell operating on FR2 of the SCG the UE prefers to be temporarily configured in uplink;
1> if the UE prefers to deactivate the SCG:
   2> include deactivateSCG in the OverheatingAssistance IE;
1> if the UE prefers to release the SCG:
   2> include releaseSCG in the OverheatingAssistance IE;

### UEAssistanceInformation

The UEAssistanceInformation message is used for the indication of UE assistance information to the network.
Signalling radio bearer: SRB1, SRB3
RLC-SAP: AM
Logical channel: DCCH
Direction: UE to Network

### UEAssistanceInformation Message

-- ANS1START
-- TAG-UEASSISTANCEINFORMATION-START

| UEAssistanceInformation ::= | SEQUENCE { | |
|---|---|---|
| criticalExtensions | CHOICE { | |
| ueAssistanceInformation | UEAssistanceInformation-IEs, | |
| criticalExtensionsFuture | SEQUENCE { } | |
| } | | |
| } | | |
| UEAssistanceInformation-IEs ::= | SEQUENCE { | |
| delayBudgetReport | DelayBudgetReport | OPTIONAL, |
| lateNonCriticalExtension | OCTET STRING | OPTIONAL, |
| nonCriticalExtension | UEAssistanceInformation-v1540-IEs | OPTIONAL |
| } | | |
| DelayBudgetReport::= | CHOICE { | |
| type1 | ENUMERATED { | |
| | msMinus1280, msMinus640, msMinus320, msMinus160, msMinus80, msMinus60, | |
| | msMinus40, | |
| | msMinus20, ms0, ms20ms40, ms60, ms80, ms160, ms320, ms640, ms1280}, | |
| . . . | | |
| } | | |
| UEAssistanceInformation-v1540-IEs ::= SEQUENCE { | | |
| overheatingAssistance | OverheatingAssistance | OPTIONAL, |
| nonCriticalExtension | UEAssistanceInformation-v1610-IEs | OPTIONAL |
| } | | |
| OverheatingAssistance ::= | SEQUENCE { | |
| reducedMaxCCs | ReducedMaxCCs-r16 | OPTIONAL, |
| reducedMaxBW-FR1 | ReducedMaxBW-FRx-r16 | OPTIONAL, |
| reducedMaxBW-FR2 | ReducedMaxBW-FRx-r16 | OPTIONAL, |
| reducedMaxMIMO-LayersFR1 | SEQUENCE { | |
| reducedMIMO-LayersFR1-DL | MIMO-LayersDL, | |
| reducedMIMO-LayersFR1-UL | MIMO-LayersUL | |
| } OPTIONAL, | | |
| reducedMaxMIMO-LayersFR2 | SEQUENCE { | |
| reducedMIMO-LayersFR2-DL | MIMO-LayersDL, | |
| reducedMIMO-LayersFR2-UL | MIMO-LayersUL | |
| } OPTIONAL | | |

}
ReducedAggregatedBandWidth ::= ENUMERATED {mhz0, mhz10, mhz20, mhz30, mhz40, mhz50, mhz60, mhz80, mhz100,
mhz200, mhz300, mhz400}

| UEAssistanceInformation-v1540-IEs ::= SEQUENCE { | | |
|---|---|---|
| idc-Assistance-r16 | IDC-Assistance-r16 | OPTIONAL, |
| drx-Preference-r16 | DRX-Preference-r16 | OPTIONAL, |
| maxBW-Preference-r16 | MaxBW-Preference-r16 | OPTIONAL, |
| maxCC-Preference-r16 | MaxCC-Preference-r16 | OPTIONAL, |
| maxMIMO-LayerPreference-r16 | MaxMIMO-LayerPreference-r16 | OPTIONAL, |
| minSchedulingOffsetPreference-r16 | MinSchedulingOffsetPreference-r16 | OPTIONAL, |
| releasePreference-r16 | ReleasePreference-r16 | OPTIONAL, |
| sl-UE-AssistanceInformationNR-r16 | SL-UE-AssistanceInformationNR-r16 | OPTIONAL, |
| referenceTimeInfoPreference-r16 | BOOLEAN | OPTIONAL, |
| nonCriticalExtension | UEAssistanceInformation-v17xy-IEs | OPTIONAL |
| } | | |
| UEAssistanceInformation-v17xy-IEs ::= SEQUENCE { | | |
| overheatingAssistance-r17 | OverheatingAssistance-r17 | OPTIONAL, |
| nonCriticalExtension | SEQUENCE { } | OPTIONAL |
| } | | |
| OverheatingAssistance-r17 ::= | SEQUENCE { | |
| deactivateSCG | ENUMERATED { true } OPTIONAL, | |
| releaseSCG | ENUMERATED { true } OPTIONAL | |
| } | | |

-- TAG-UEASSISTANCEINFORMATION-STOP
-- ASN1STOP

### Example Embodiments C and D

Examples for the Inter-Node Message (INM) aspects are detailed below.

### 3GPP TS 38.331 11.2.2 Message Definitions

### HandoverPreparationInformation

This message is used to transfer the NR RRC information used by the target gNB during handover preparation or UE context retrieval, e.g., in case of resume or re-establishment, including UE capability information. This message is also used for transferring the information between the CU and DU.
Direction: source gNB/source RAN to target gNB or CU to DU.

### HandoverPreparationInformation Message

-- ANS1START
-- TAG-HANDOVER-PREPARATION-INFORMATION-START

| HandoverPreparationInformation ::= | SEQUENCE { |
|---|---|
| criticalExtensions | CHOICE { |
| c1 | CHOICE{ |
| handoverPreparationInformation | HandoverPreparationInformation-IEs, |
| spare3 NULL, spare2 NULL, spare1 NULL | |
| }, | |
| criticalExtensionsFuture | SEQUENCE { } |
| } | |
| } | |
| HandoverPreparationInformation-IE ::= | SEQUENCE { |
| ue-CapabilityRAT-List | UE-CapabilityRAT-ContainerList, |

| | | |
|---|---|---|
| sourceConfig | AS-Config | OPTIONAL, -- Cond HO |
| rm-Config | RRM-Config | OPTIONAL, |
| as-Context | AS-Context | OPTIONAL, |
| nonCriticalExtension | SEQUENCE { } | OPTIONAL |

| | |
|---|---|
| } | |
| AS-Config ::= | SEQUENCE { |
| rrcReconfiguration | OCTET STRING (CONTAINING RRCReconfiguration), |
| . . . , | |
| [[ | |

| | | |
|---|---|---|
| sourceRB-SN-Config | OCTET STRING (CONTAINING RadioBearerConfig) | OPTIONAL, |
| sourceSCG-NR-Config | OCTET STRING (CONTAINING RRCReconfiguration) | OPTIONAL, |
| sourceSCG-EUTRA-Config | OCTET STRING | OPTIONAL |
| ]], | | |
| [[ | | |
| sourceSCG-Configured | ENUMERATED {true} | OPTIONAL |

| ]] | | |
|---|---|---|
| } | | |
| AS-Context ::= | SEQUENCE { | |
| reestablishmentInfo | ReestablishmentInfo | OPTIONAL, |
| configRestrictInfo | ConfigRestrictInfoSCG | OPTIONAL, |
| . . . , | | |
| [[ ran-NotificationAreaInfo | RAN-NotificationAreaInfo | OPTIONAL |
| ]], | | |
| [[ ueAssistanceInformation | OCTET STRING (CONTAINING UEAssistanceInformation) | OPTIONAL -- Cond HO2 |
| ]], | | |
| [[ | | |
| selectedBandCombinationSN | BandCombinationInfoSN | OPTIONAL |
| ]], | | |
| [[ | | |
| configRestrictInfoDAPS-r16 | ConfigRestrictInfoDAPS-r16 | OPTIONAL, |
| sidelinkUEInformationNR-r16 | OCTET STRING | OPTIONAL, |
| sidelinkUEInformationEUTRA-r16 | OCTET STRING | OPTIONAL, |
| ueAssistanceInformationEUTRA-r16 | OCTET STRING | OPTIONAL, |
| ueAssistanceInformationSCG-r16 | OCTET STRING (CONTAINING UEAssistanceInformation) | OPTIONAL, -- Cond HO2 |
| needForGapsInfoNR-r16 | NeedForGapsInfoNR-r16 | OPTIONAL |
| ]] | | |
| } | | |
| ConfigRestrictInfoDAPS-r16 ::= | SEQUENCE { | |
| powerCoordination-r16 | SEQUENCE { | |
| p-DAPS-Source-r16 | P-Max, | |
| p-DAPS-Target-r16 | P-Max, | |
| uplinkPowerSharingDAPS-Mode-r16 | ENUMERATED {semi-static-mode1, semi-static-mode2, dynamic } | |
| } | | OPTIONAL |
| } | | |

| | |
|---|---|
| ReestablishmentInfo ::= | SEQUENCE { |

| | |
|---|---|
| sourcePhysCellId | PhysCellId, |
| targetCellShortMAC-I | ShortMAC-I, |

| | | |
|---|---|---|
| additionalReestabInfoList | ReestabNCellInfoList | OPTIONAL |

}

| | |
|---|---|
| ReestabNCellInfoList ::= | SEQUENCE ( SIZE (1..maxCellPREP) ) OF ReestabNCellInfo |

| | |
|---|---|
| ReestabNCellInfo::= SEQUENCE{ | |
| cellIdentity | CellIdentity, |
| key-gNodeB-Star | BIT STRING (SIZE (256)), |
| shortMAC-I | ShortMAC-I |
| } | |

| | |
|---|---|
| RRM-Config ::= | SEQUENCE { |

| | |
|---|---|
| ue-InactiveTime | ENUMERATED { |

s1, s2, s3, s5, s7, s10, s15, s20,
s25, s30, s40, s50, min1, min1s20, min1s40,
min2, min2s30, min3, min3s30, min4, min5, min6,
min7, min8, min9, min10, min12, min14, min17, min20,
min24, min28, min33, min38, min44, min50, hr1,
hr1min30, hr2, hr2min30, hr3, hr3min30, hr4, hr5, hr6,
hr8, hr10, hr13, hr16, hr20, day1, day1hr12, day2,
day2hr12, day3, day4, day5, day7, day10, day14, day19,

| | |
|---|---|
| day24, day30, dayMoreThan30} | OPTIONAL, |

| | | |
|---|---|---|
| candidateCellInfoList | MeasResultList2NR | OPTIONAL, |

```
  . . . ,
  [[
```

| | | |
|---|---|---|
| candidateCellInfoListSN-EUTRA | MeasResultServFreqListEUTRA-SCG | OPTIONAL |

]]
}

-- TAG-HANDOVER-PREPARATION-INFORMATION-STOP
-- ANS1STOP

AS-Context field descriptions

configRestrictInfoDAPS
Includes fields for which souce cell explictly indicates the
restriction to be observed by target cell during DAPS handover.
needForGapsInfoNR
Includes measurement gap requirement information of the UE for
NR target bands.
selectedBandCombinationSN
Indicates the band combination selected by SN in (NG)EN-DC,
NE-DC, and NR-DC.
sidelinkUEInformationEUTRA
This field includes SidelinkUEInformation IE as specified in
TS 36.331 [10].
sidelinkUEInformationNR
This field includes SidelinkUEInformationNR IE.
ueAssistanceInformation
Includes for each UE assistance feature the information last
reported by the UE, if any.
ueAssistanceInformationSCG
Includes for each UE assistance feature associated with the
SCG, the information last reported by the UE in the NR
UEAssistanceInformation message for the SCG, if any.

### CG-ConfigInfo

This message is used by master eNB or gNB to request the SgNB or SeNB to perform certain actions e.g., to establish, modify or release an SCG. The message may include additional information e.g., to assist the SgNB or SeNB to set the SCG configuration. It can also be used by a CU to request a DU to perform certain actions, e.g., to establish, or modify an MCG or SCG.
Direction: Master eNB or gNB to secondary gNB or eNB, alternatively CU to DU.

### CG-ConfigInfo Message

-- ANS1START
-- TAG-CG-CONFIG-INFO-START

| | |
|---|---|
| CG-ConfigInfo ::= | SEQUENCE { |

| | |
|---|---|
| criticalExtensions | CHOICE { |

| c1 | CHOICE{ |
|---|---|
| cg-ConfigInfo | CG-ConfigInfo-IEs, |
| spare3 NULL, spare2 NULL, spare1 NULL, | |
| }, | |
| criticalExtensionsFuture | SEQUENCE { } |
| } | |
| } | |

| | |
|---|---|
| CG-ConfigInfo-IE ::= | SEQUENCE { |

| | | |
|---|---|---|
| ue-CapabilityInfo | OCTET STRING (CONTAINING UE- | OPTIONAL, -- Cond |
| | CapabilityRAT-Containerlist) | SN-AddMod |
| candidateCellInfoListMN | MeasResultList2NR | OPTIONAL, |
| candidateCellInfoListSN | OCTET STRING (CONTAINING | OPTIONAL, |
| | MeasResultList2NR) | |
| measResultCellListSFTD-NR | MeasResultCellListSFTD-NR | OPTIONAL, |

| | |
|---|---|
| scgFailureInfo | SEQUENCE { |

| | |
|---|---|
| failureType | ENUMERATED { t310-Expiry, randomAccessProblem, |
| | rlc-MaxNumRetx, synchReconfigFailure-SCG, |
| | scg-reconfigFailure, |
| | srb3-IntegrityFailure}, |
| measResultSCG | OCTET STRING {CONTAINING MeasResultSCG-Failure) |

| | |
|---|---|
| } | OPTIONAL, |

| | | |
|---|---|---|
| configRestrictInfo | ConfigRestrictInfoSCG | OPTIONAL, |
| drx-InfoMCG | DRX-Info | OPTIONAL, |
| measConfigMN | MeasConfigMN | OPTIONAL, |
| sourceConfigSCG | OCTET STRING (CONTAINING | OPTIONAL, |
| | RRCReconfiguration) | |
| scg-PB-Config | OCTET STRING (CONTAINING | OPTIONAL, |
| | RadioBearerConfig) | |
| mcg-RB-Config | OCTET STRING (CONTAINING | OPTIONAL, |
| | RadioBearerConfig) | |
| mrdc-AssistanceInfo | MRDC-AssistanceInfo | OPTIONAL, |
| nonCriticalExtension | CG-ConfigInfo-v1540-IEs | OPTIONAL |

}

| | |
|---|---|
| CG-ConfigInfo-v1540-IEs ::= | SEQUENCE { |

| | | |
|---|---|---|
| ph-InfoMCG | PH-TypeListMCG | OPTIONAL, |
| measReultReportCGI | SEQUENCE { | |

| | | |
|---|---|---|
| ssbFrequency | ARFCN-ValueNR, | |
| cellForWhichToReportCGI | PhysCellId, | |
| cgi-Info | CGI-InfoNR | |
| } | | OPTIONAL, |

| | | |
|---|---|---|
| nonCriticalExtension | CG-ConfigInfo-v1560-IEs | OPTIONAL |

| } | | |
|---|---|---|
| CG-ConfigInfo-v1560-IEs ::= SEQUENCE { | | |
| candidateCellInfoListMN-EUTRA | OCTET STRING | OPTIONAL, |
| candidateCellInfoListSN-EUTRA | OCTET STRING | OPTIONAL, |
| sourceConfigSCG-EUTRA | OCTET STRING | OPTIONAL, |

| | |
|---|---|
| scgFailureInfoEUTRA | SEQUENCE { |
| failureTypeEUTRA | ENUMERATED { t313-Expiry, randomAccessProblem, |
| | rlc-MaxNumRetx, scg-ChangeFailure}, |
| measResultSCG-EUTRA | OCTET STRING |

| } | | OPTIONAL, |
|---|---|---|
| drx-ConfigMCG | DRX-Config | OPTIONAL, |
| measResultReportCGI-EUTRA | SEQUENCE { | |
| eutraFrequency | ARFCN-ValueEUTRA, | |
| cellForWhichToReportCGI-EUTRA | EUTRA-PhysCellId, | |
| cgi-InfoEUTRA | CGI-InfoEUTRA | |
| } | | OPTIONAL, |
| measResultCellListSFTD-EUTRA | MeasResultCellListSFTD-EUTRA | OPTIONAL, |
| fr-InfoListMCG | FR-InfoList | OPTIONAL, |
| nonCriticalExtension | CG-ConfigInfo-v1570-IEs | OPTIONAL |
| } | | |
| CG-ConfigInfo-v1570-IEs ::= SEQUENCE { | | |
| sftdFrequencyList-NR | SFTD-FrequencyList-NR | OPTIONAL, |
| sftdFrequencyList-EUTRA | SFTD-FrequencyList-EUTRA | OPTIONAL, |
| nonCriticalExtension | CG-ConfigInfo-v1590-IEs | OPTIONAL |
| } | | |

| CG-ConfigInfo-v1590-IEs ::= SEQUENCE { | | |
|---|---|---|
| servFrequenciesMN-NR | SEQUENCE (SIZE (1.. | OPTIONAL, |
| | maxNrofServingCells-1)) | |
| | OF ARFCN-ValueNR | |
| nonCriticalExtension | CG-ConfigInfo-v1610-IEs | OPTIONAL |

}

| CG-ConfigInfo-v1610-IEs ::= SEQUENCE { | | |
|---|---|---|
| drx-InfoMCG2 | DRX-Info2 | |
| alignedDRX-Indication | ENUMERATED {true} | OPTIONAL, |

| | | |
|---|---|---|
| scgFailureInfo-r16 | SEQUENCE { | OPTIONAL, |

| failureType-r16 | ENUMERATED { scg-lbtFailure-r16, |
|---|---|
| | beamFailureRecoveryFailure-r16, |
| | t312-Expiry-r16, bh-RLF-r16, |
| | spare4, spare3, spare2, spare1}, |
| measResultSCG-r16 | OCTET STRING (CONTAINING |
| | MeasResultSCG-Failure) |

| | |
|---|---|
| } | OPTIONAL, |

| scgFailureInfoEUTRA-r16 | SEQUENCE { |
|---|---|
| failureTypeEUTRA-r16 | ENUMERATED { scg-lbtFailure-r16, |
| | beamFailureRecoveryFailure-r16, |
| | t312-Expiry-r16, bh-RLF-r16, |
| | spare4, spare3, spare2, spare1}, |
| measResultSCG-EUTRA-r16 | OCTET STRING |

| | |
|---|---|
| } | OPTIONAL, |

| | | |
|---|---|---|
| sidelinkUEInformationNR-r16 | OCTET STRING (CONTAINING | OPTIONAL, |
| | SidelinkUEInformationNR-r16) | |
| sidelinkUEInformationEUTRA-r16 | OCTET STRING | OPTIONAL, |
| nonCriticalExtension | CG-ConfigInfo-v1620-IEs | OPTIONAL |

| | | |
|---|---|---|
| } | | |
| CG-ConfigInfo-v1620-IEs ::= | SEQUENCE { | |
| ueAssistanceInformationSourceSCG-r16 | OCTET STRING (CONTAINING | OPTIONAL, |
| | UEAssistanceInformation) | |
| nonCriticalExtension | SEQUENCE { } | OPTIONAL |

}

| | |
|---|---|
| SFTD-FrequencyList-NR ::= | SEQUENCE (Size (1..maxCellSFTD)) OF ARFCN-ValueNR |
| SFTD-FrequencyList-EUTRA ::= | SEQUENCE (Size (1..maxCellSFTD)) OF ARFCN- |
| | ValueEUTRA |

| | |
|---|---|
| ConfigRestrictInfoSCG ::= | SEQUENCE { |

| | | |
|---|---|---|
| allowedBC-ListMRDC | BandCombinationInfoList | OPTIONAL, |

| | | |
|---|---|---|
| powerCoordination-FR1 | SEQUENCE { | |
| p-maxNR-FR1 | P-Max | OPTIONAL, |
| p-maxEUTRA | P-Max | OPTIONAL, |
| p-maxUE-FR1 | P-Max | OPTIONAL |
| } | | OPTIONAL, |

| | |
|---|---|
| servCellIndexRangeSCG | SEQUENCE { |

| | | |
|---|---|---|
| lowBound | ServCellIndex | |
| upBound | ServCellIndex | |
| } | | OPTIONAL, -- |
| | | Cond SN-AddMod |
| maxMeasFreqsSCG | INTEGER(1..maxMeasFreqsMN) | OPTIONAL, |
| dummy | INTEGER(1..maxMeasIdentitiesMN) | OPTIONAL, |
| . . . , | | |
| [[ | | |

| | | |
|---|---|---|
| selectedBandEntriesMNList | SEQUENCE (Size (1..maxBandComb)) OF | OPTIONAL, |
| | SelectedBandEntriesMN | |
| pdcch-BlindDetectionSCG | INTEGER(1..15) | OPTIONAL, |
| maxNumberROHC-ContextSessionsSN | INTEGER(0.. 16384) | OPTIONAL, |

| | | |
|---|---|---|
| ]], | | |
| [[ | | |
| maxIntraFreqMeasIdentitiesSCG | INTEGER(1..maxMeasIdentitiesMN) | OPTIONAL, |
| maxInterFreqMeasIdentitiesSCG | INTEGER(1..maxMeasIdentitiesMN) | OPTIONAL |

```
  ]],
  [[
```

| | | |
|---|---|---|
| p-maxNR-FR1-MCG-r16 | P-Max | OPTIONAL, |

| | |
|---|---|
| powerCoordination-FR2-r16 | SEQUENCE { |

| | | |
|---|---|---|
| p-maxNR-F2-MCG-r16 | P-Max | OPTIONAL, |
| p-maxNR-F2-SCG-r16 | P-Max | OPTIONAL, |
| p-maxUE-F2-r16 | P-Max | OPTIONAL |
| } | | OPTIONAL, |

| nrdc-PC-mode-FR1-r16 ENUMERATED (semi-static-mode1, semi-static- | | OPTIONAL, |
|---|---|---|
| mode2, dynamic) | | |
| nrdc-PC-mode-FR2-r16 ENUMERATED (semi-static-mode1, semi-static- | | OPTIONAL, |
| mode2, dynamic) | | |
| maxMeasBRS-ResourceSCG-r16 | INTEGER(0..maxNrofCLI-SRS- | OPTIONAL, |
| | Resources-r16) | |
| maxMeasCLI-ResourceSCG-r16 | INTEGER(0..maxNrofCLI-RSSI- | OPTIONAL, |
| | Resources-r16) | |
| maxNumberEHC-ContextsSN-r16 | INTEGER(0..65536) | OPTIONAL, |

| | | |
|---|---|---|
| allowedReducedConfigForOverheating-r16 | OverheatingAssistance | OPTIONAL, |

| | | |
|---|---|---|
| maxToffset-r16 | T-Offset-r16 | OPTIONAL |

]]
}

| SelectedBandEntriesMN ::= | SEQUENCE (SIZE (1..maxSimultaneousBands)) OF BandEntryIndex |
|---|---|
| BandEntryIndex ::= | INTEGER (0.. maxNrofServingsCells) |
| PH-TypeListMCG ::= | SEQUENCE (SIZE (1..maxNrofServingsCells)) OF PH-InfoMCG |
| PH-InfoMCG ::= | SEQUENCE { |

| | |
|---|---|
| servCellIndex | ServCellIndex, |
| ph-Uplink | PH-UplinkCarrierMCG, |

| | | |
|---|---|---|
| ph-SupplementaryUplink | PH-UplinkCarrierMCG | OPTIONAL, |

. . .
}

| | |
|---|---|
| PH-UplinkCarrierMCG ::= | SEQUENCE{ |

| | |
|---|---|
| ph-Type1or3 | ENUMERATED {type1, type3}, |
| . . . | |
| } | |

| BandCombinationInfoList ::= | SEQUENCE (SIZE (1..maxBandComb)) OF BandCombinationInfo |
|---|---|
| BandCombinationInfo ::= | SEQUENCE { |

| | |
|---|---|
| bandCombinationIndex | BandCombinationIndex, |

| | |
|---|---|
| allowedFeatureSetsList | SEQUENCE (SIZE (1..maxFeatureSetsPerBand)) OF |
| | FeatureSetEntryIndex |

}

| | |
|---|---|
| FeatureSetEntryIndex ::= | INTEGER (1.. maxFeatureSetsPerBand) |
| DRX-Info ::= | SEQUENCE { |

| | |
|---|---|
| drx-LongCycleStartOffset | CHOICE { |

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..169), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |
| }, | |
| shortDRX | SEQUENCE { |
| drx-ShortCycle | ENUMERATED { |

| | ms2, ms3, ms4, ms5, ms6, ms7, ms8, ms10, ms14, ms16, | |
|---|---|---|
| | ms20, ms30, ms32, | |
| | ms35, ms40, ms64, ms80, ms128, ms160, ms256, ms320, | |
| | ms512, ms640, spare9, | |
| | spare8, spare7, spare6, spare5, spare4, spare3, spare2, | |
| | spare1 }, | |
| drx-ShortCycleTimer | INTEGER (1..16) | OPTIONAL |

}
}

| | |
|---|---|
| DRX-Info2 ::= | SEQUENCE { |

| | |
|---|---|
| drx-onDurationTimer | CHOICE { |

subMilliSeconds INTEGER (1..31),
milliSeconds ENUMERATED {

ms1, ms2, ms3, ms4, ms5, ms6, ms8, ms10, ms20, ms30, ms40,
ms50, ms60,
ms80, ms100, ms200, ms300, ms400, ms500, ms600, ms800,
ms1000, ms1200,
ms1600, spare8, spare7, spare6, spare5, spare4, spare3, spare2,
spare1 }

}

}
MeasConfigMN ::= SEQUENCE {

| | | |
|---|---|---|
| measuredFrequenciesMN | SEQUENCE (SIZE | OPTIONAL, |
| | {1..maxMeasFreqsMN)) | |
| | OF NR-FreqInfo | |
| measGapConfig | SetupRelease { GapConfig } | OPTIONAL, |
| gapPurpose | ENUMERATED {perUE, perFR1} | OPTIONAL, |
| . . . , | | |
| [[ | | |
| measGapConfigFR2 | SetupRelease { GapConfig } | OPTIONAL |

| ]] | |
|---|---|
| } | |
| MRDC-AssistanceInfo ::= SEQUENCE { | SEQUENCE (SIZE (1..maxNrofCombIDC)) OF |
| | AffectedCarrierFreqCombInfoMRDC, |
| affectedCarrierFreqCombInfoListMRDC | |
| . . . , | |
| [[ | |

| | | |
|---|---|---|
| overheatingAssistanceSCG-r16 | OCTET STRING {CONTAINING | OPTIONAL |

OverheatingAssistance}

```
  ]],
  [[
```

| | | |
|---|---|---|
| ue-SCGPreference-r17 | OCTET STRING | OPTIONAL |

{CONTAININGscgPreference}

| ]] | |
|---|---|
| } | |
| AffectedCarrierFreqCombInfoMRDC ::= SEQUENCE { | |
| victimSystemType | VictimSystemType, |
| interferenceDirectionMRDC | ENUMERATED {eutra-nr, nr, other, utra-nr-other, nr-other, |
| | spare3, spare2, spare1}, |
| affectedCarrierFreqCombMRDC | SEQUENCE { |

| | | |
|---|---|---|
| affectedCarrierFreqCombEUTRA | AffectedCarrierFreqCombEUTRA | OPTIONAL, |
| affectedCarrierFreqCombNR | AffectedCarrierFreqCombNR | |
| } | | OPTIONAL, |

}
VictimSystemType ::= SEQUENCE {

| | | |
|---|---|---|
| gps | ENUMERATED {true} | OPTIONAL, |
| glomass | ENUMERATED {true} | OPTIONAL, |
| bds | ENUMERATED {true} | OPTIONAL, |
| galileo | ENUMERATED {true} | OPTIONAL, |
| wlan | ENUMERATED {true} | OPTIONAL, |
| bluetooth | ENUMERATED {true} | OPTIONAL |

}

AffectedCarrierFreqCombEUTRA ::= SEQUENCE (SIZE (1..maxNrofServingCellsEUTRA))
OF ARFCN-ValueEUTRA
AffectedCarrierFreqCombNR ::= SEQUENCE (SIZE (1..maxNrofServingCells)) OF ARFCN-ValueNR

-- TAG-CG-CONFIG-INFO-STOP
-- ASN1STOP

CG-ConfigInfo field descriptions

ueSCGPreference
Includes the UE assistance information related to SCG activation.

### CG-Config

This message is used to transfer the SCG radio configuration as generated by the SgNB or SeNB. It can also be used by a CU to request a DU to perform certain actions, e.g., to request the DU to perform a new lower layer configuration.
Direction: Secondary gNB or eNB to master gNB or eNB, alternatively CU to DU.

### CG-Config Message

-- ASN1START
-- TAG-CG-CONFIG-START

| | |
|---|---|
| CG-Config ::= | SEQUENCE { |

| | |
|---|---|
| criticalExtensions | CHOICE { |

| c1 | CHOICE { |
|---|---|
| cg-Config | CG-Config-IEs, |
| spare3 NULL, spare2 NULL, spare1 NULL | |
| }, | |
| criticalExtensionsFuture | SEQUENCE { } |
| } | |
| } | |

| | |
|---|---|
| CG-Config-IEs ::= | SEQUENCE { |

| | | |
|---|---|---|
| scg-CellGroupConfig | OCTET STRING (CONTAINING | OPTIONAL, |
| | RRCReconfiguration) | |
| scg-RB-Config | OCTET STRING (CONTAINING | OPTIONAL, |
| | RadioBearerConfig) | |
| configRestrictModReq | ConfigRestrictModReqSCG | OPTIONAL, |
| drx-InfoSCG | DRX-Info | OPTIONAL, |
| candidateCellInfoListSN | OCTET STRING (CONTAINING | OPTIONAL, |
| | MeasResultList2NR) | |
| measConfigSN | MeasConfigSN | OPTIONAL, |
| selectedBandCombination | BandCombinationInfoSN | OPTIONAL, |
| fr-InfoListSCG | FR-InfoList | OPTIONAL, |
| candidateServingFreqListNR | CandidateServingFreqListNR | OPTIONAL, |
| nonCriticalExtension | CG-Config-v1540-IEs | OPTIONAL |

}

| | |
|---|---|
| CG-Config-v1540-IE ::= | SEQUENCE { |

| | | |
|---|---|---|
| pSCellFrequency | ARFCN-ValueNR | OPTIONAL |
| reportCGI-RequestNR | SEQUENCE { | |

| | | |
|---|---|---|
| requestedCellInfo | SEQUENCE { | |
| ssbFrequency | ARFCN-ValueNR, | |
| cellForWhichToReportCGI | PhysCellId | |
| } | | OPTIONAL |
| } | | OPTIONAL, |

| | | |
|---|---|---|
| ph-InfoSCG | PH-TypeListSCG | OPTIONAL, |
| nonCriticalExtension | CG-Config-v1560-IEs | OPTIONAL |

}

| | |
|---|---|
| CG-Config-v1560-IEs ::= | SEQUENCE { |

| | | |
|---|---|---|
| pSCellFrequencyEUTRA | ARFCN-ValueEUTRA | OPTIONAL, |
| scg-CellGroupConfigEUTRA | OCTET STRING | OPTIONAL, |
| candidateCellInfoListSN-EUTRA | OCTET STRING | OPTIONAL, |
| candidateServingFreqListEUTRA | CandidateServingFreqListEUTRA | OPTIONAL, |
| needForGaps | ENUMERATED {true} | OPTIONAL, |
| drx-ConfigSCG | DRX-Config | OPTIONAL, |
| reportCGI-RequestEUTRA | SEQUENCE { | |
| requestedCellInfoEUTRA | SEQUENCE { | |

| | | |
|---|---|---|
| eutraFrequency | ARFCN-ValueEUTRA, | |
| cellForWhichToReportCGI-EUTRA | EUTRA-PhysCellId | |
| } | | OPTIONAL, |
| } | | OPTIONAL, |

| | | |
|---|---|---|
| nonCriticalExtension | CG-Config-v1690-IEs | OPTIONAL |

}

| | |
|---|---|
| CG-Config-v1590-IEs ::= | SEQUENCE { |

| | | |
|---|---|---|
| scellFrequenciesSN-NR | SEQUENCE (SIZE (1.. maxNrofServingCells-1)) | OPTIONAL, |
| | OF ARFCN-ValueNR | |
| scellFrequenciesSN-EUTRA | SEQUENCE (SIZE (1.. maxNrofServingCells-1)) | OPTIONAL, |
| | OF ARFCN-ValueEUTRA | |
| nonCriticalExtension | CG-Config-v1620-IEs | OPTIONAL |

}

| | |
|---|---|
| CG-Config-v1610-IEs ::= | SEQUENCE { |

| | | |
|---|---|---|
| drx-InfoSCG2 | DRX-Info2 | OPTIONAL, |
| nonCriticalExtension | CG-Config-v1620-IEs | OPTIONAL |

}

| | |
|---|---|
| CG-Config-v1620-IEs ::= | SEQUENCE { |

| | | |
|---|---|---|
| ueAssistanceInformationSCG-r16 | OCTET STRING (CONTAINING | OPTIONAL, |
| | UEAssistanceInformation) | |
| nonCriticalExtension | CG-Config-v1630-IEs | OPTIONAL |

}

| | |
|---|---|
| CG-Config-v1630-IEs ::= | SEQUENCE { |

| | | |
|---|---|---|
| selectedToffset-r16 | T-Offset-r16 | OPTIONAL, |
| nonCriticalExtension | SEQUENCE { } | OPTIONAL |

}

| | |
|---|---|
| PH-TypeListSCG ::= | SEQUENCE (SIZE (1..maxNrofServingCells)) OF PH-InfoSCG |
| PH-InfoSCG ::= | SEQUENCE { |

| servCellIndex | ServCellIndex, | |
|---|---|---|
| ph-Uplink | PH-UplinkCarrierSCG | |
| ph-SupplementaryUplink | PH-UplinkCarrierSCG | OPTIONAL, |

. . .
}

| | |
|---|---|
| PH-UplinkCarrierSCG ::= | SEQUENCE{ |

| | |
|---|---|
| ph-Type1or3 | ENUMERATED {type1, type3}, |

. . .
}

| | |
|---|---|
| MeasConfigSN ::= | SEQUENCE { |

| | | |
|---|---|---|
| measuredFrequenciesSN | SEQUENCE (SIZE (1..maxMeasFreqSN)) | OPTIONAL, |
| | OF NR-FreqInfo | |

. . .
}

| | |
|---|---|
| NR-FreqInfo ::= | SEQUENCE { |

| | | |
|---|---|---|
| measuredFrequency | ARFCN-ValueNR | OPTIONAL, |

. . .
}

| | |
|---|---|
| ConfigRestrictModReqSCG ::= | SEQUENCE { |

| | | |
|---|---|---|
| requestedBC-MRDC | BandCombinationInfoSN | OPTIONAL, |
| requestedP-MaxFR1 | P-Max | OPTIONAL, |

```
  . . . ,
  [[
```

| | | |
|---|---|---|
| requestedPDCCH-BlindDetectionSCG | INTEGER (1..15) | OPTIONAL, |
| requestedP-MaxEUTRA | P-Max | OPTIONAL |

```
  ]],
  [[
```

| | | |
|---|---|---|
| requestedP-MaxFR2-r16 | P-Max | OPTIONAL, |
| requestedMaxInterFreqMeasIdSCG-r16 | INTEGER(1..maxMeasIdentitiesMN) | OPTIONAL, |
| requestedMaxIntraFreqMeasIdSCG-r16 | INTEGER(1..maxMeasIdentitiesMN) | OPTIONAL, |
| requestedToffset-r16 | T-Offset-r16 | OPTIONAL |

]]
}

| BandCombinationIndex ::= INTEGER (1..maxBandComb) | |
|---|---|
| BandCombinationInfoSN ::= | SEQUENCE { |

| | |
|---|---|
| bandCombinationIndex | BandCombinationIndex, |
| requestedFeatureSets | FeatureSetEntryIndex |

}
FR-InfoList ::= SEQUENCE (SIZE (1..maxNrofServingCells-1)) OF FR-Info
FR-Info ::= SEQUENCE {

| | |
|---|---|
| servCellIndex | ServCellIndex, |
| fr-Type | ENUMERATED (fr1, fr2) |

}

CandidateServingFreqListNR ::= SEQUENCE (SIZE (1.. maxFreqIDC-MRDC)) OF ARFCN-ValueNR
CandidateServingFreqListEUTRA ::= SEQUENCE (SIZE (1.. maxFreqIDC-MRDC)) OF ARFCN-ValueEUTRA
T-Offset-r16 ::= ENUMERATED (ms0dot5, ms0dot75, ms1, ms1dot5, ms2, ms2dot5, ms3, spare1)

-- TAG-CG-CONFIG-STOP
-- ASN1STOP

CG-Config field descriptions

scg-CellGroupConfig
Contains the RRCReconfiguration message (containing only
secondaryCellGroup and/or measConfig and/or otherConfig and/or
conditionalReconfiguration and/or bap-Config and/or
iab-IP-AddressConfigurationList):
to be sent to the UE, used upon SCG establishment or modification,
as generated (entirely) by the (target) SgNB. In this case, the SN
sets the RRCReconfiguration message in accordance with clause 6 e.g.
regarding the “Need” or “Cond” statements.
or
including the current SCG configuration of the UE, when provided in
response to a query from MN, or in SN triggered SN change in order to
enable delta signaling by the target SN. In this case, the SN sets
the RRCReconfiguration message in accordance with clause 11.2.3.
The field is absent if neither SCG (re)configuration nor SCG
configuration query nor SN triggered SN change is performed, e.g.
at inter-node capability/configuration coordination which does not
result in SCG (re)configuration towards the UE. This field is not
applicable in NE-DC.
scg-CellGroupConfigEUTRA
Includes the E-UTRA RRCConnectionReconfiguration message as
specified in TS 36.331 [10]. In this version of the specification, the
E-UTRA RRC message can only include the field scg-Configuration:
to be sent to the UE, used to (re-)configure the SCG configuration
upon SCG establishment or modification, as generated (entirely) by
the (target) SeNB. In this case, the SN sets the scg-Configuration
within the EUTRA RRCConnectionReconfiguration message in
accordance with clause 6 in TS 36.331 [10] e.g. regarding the “Need” or
“Cond” statements.
or
including the current SCG configuration of the UE, when provided in
response to a query from MN, or in SN triggered SN change in order
to enable delta signalling by the target SN.
The field is absent if neither SCG (re)configuration nor SCG
configuration query nor SN triggered SN change is performed, e.g.
at inter-node capability/configuration coordination which does not
result in SCG (re)configuration towards the UE. This field is only
used in NE-DC.
scg-RB-Config
Contains the IE RadioBearerConfig:
to be sent to the UE, used to (re-)configure the SCG RB configuration
upon SCG establishment or modification, as generated (entirely) by
the (target) SgNB or SeNB. In this case, the SN sets the
RadioBearerConfig in accordance with clause 6, e.g. regarding the
“Need” or “Cond” statements.
or
including the current SCG RB configuration of the UE, when provided
in response to a query from MN or in SN triggered SN change or in
SN triggered SN release or bearer type change between SN terminated
bearer to MN terminated bearer in order to enable delta signaling
by the MN or target SN. In this case, the SN sets the
RadioBearerConfig in accordance with clause 11.2.3.
The field is absent if neither SCG (re)configuration nor SCG
configuration query nor SN triggered SN change nor SN triggered SN
release is performed, e.g. at inter-node capability/configuration
coordination which does not result in SCG RB (re)configuration.
selectedBandCombination
Indicates the band combination selected by SN in (NG)EN-DC,
NE-DC,and NR-DC.
The SN should inform the MN with this field whenever the band
combination and/or feature set it selected for the SCG changes
(i.e. even if the new selection concerns a band combination and/or
feature set that is allowed by the allowedBC-ListMRDC)
selectedToffset
Indicates the value used by the SN for scheduling SCG transmissions
(i.e. T_{proc, SCG}^{max}, see TS 38.213 [13]). This field is used in NR-DC
only when the fields nrdc-PC-mode-FR1-r16 or nrdc-PC-mode-FR2-r16
are set to dynamic. The SN can only indicate a value that is less than
or equal to maxToffset received from MN. This field is used in NR-DC
only when MN has included the field maxToffset in CG-ConfigInfo.
Value ms0dot5 corresponds to 0.5 ms, value ms0dot75 corresponds to
0.75 ms, value ms1 corresponds to 1 ms and so on.
ueAssistanceInformationSCG
Includes for each UE assistance feature associated with the SCG,
the information last reported by the UE in the NR
UEAssistanceInformation message for the SCG, if any.

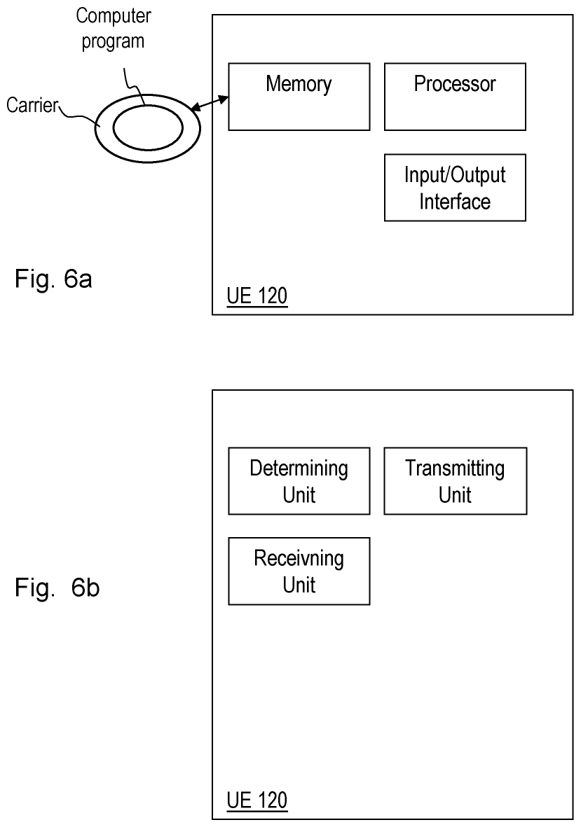

FIGS. 6a and 6b shows an example of arrangement in the UE 120.

The UE 120 may comprise an input and output interface configured to communicate with each other. The input and output interface may comprise a wireless receiver (not shown) and a wireless transmitter (not shown).

The UE 120 may comprise a determining unit, a transmitting unit, and a receiving unit to perform the method actions as described herein. These units will be presented in below embodiments.

The embodiments herein may be implemented through a respective processor or one or more processors, such as the processor of a processing circuitry in the UE 120 depicted in FIG. 6a, together with computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise respective a memory comprising one or more memory units. The memory comprises instructions executable by the processor in the UE 120.

The memory is arranged to be used to store instructions, data, configurations, preferred modes of operations, cause values, triggering conditions and applications to perform the methods herein when being executed in the UE 120.

In some embodiments, a computer program comprises instructions, which when executed by the at least one processor, cause the at least one processor of the UE 120 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 120, described below may refer to a combination of analog and digital circuits, and/or one or more processors configured with software and/or firmware, e.g., stored in the UE 120, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

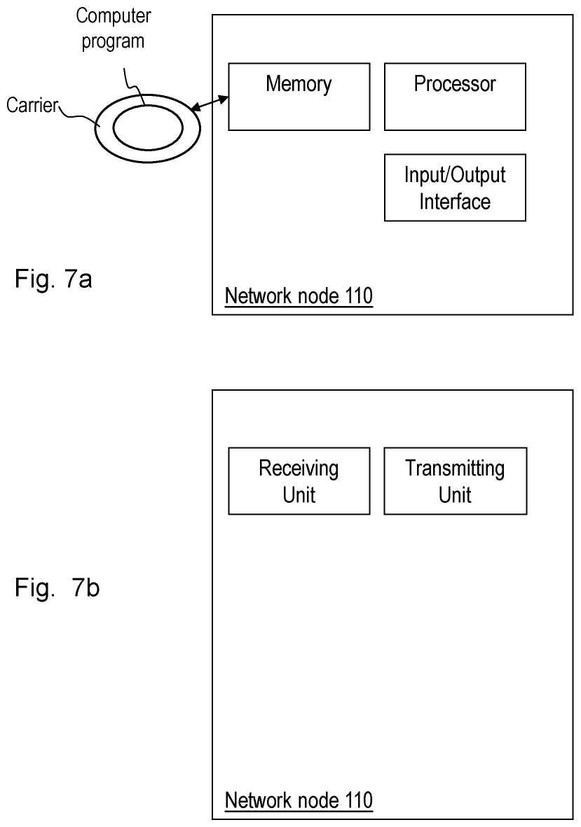

FIGS. 7a and 7b shows an example of arrangements in the network node 110.

The network node 110 may comprise an input and output interface configured to communicate with each other. The input and output interface may comprise a wireless receiver (not shown) and a wireless transmitter (not shown).

The network node 110 may comprise a receiving unit, and a transmitting unit configured to perform the method actions as described herein. These units will be presented in below embodiments.

The embodiments herein may be implemented through a respective processor or one or more processors, such as the processor of a processing circuitry in the network node 110 depicted in FIG. 7a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise respective a memory comprising one or more memory units. The memory comprises instructions executable by the processor in the network node 110.

The memory is arranged to be used to store instructions, data, configurations, preferred modes of operations, cause values, triggering conditions and applications to perform the methods herein when being executed in the network node 110.

In some embodiments, a computer program comprises instructions, which when executed by the at least one processor, cause the at least one processor of the network node 110 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g., stored in the network node 110, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Below, some example embodiments 1-14 are shortly described. See e.g., FIGS. 4, 5, 6a, 6b, 7a and 7b.

Embodiment 1. A method performed by a User Equipment, UE, 120, also referred to as a wireless terminal 120, e.g. for saving energy by handling Secondary Cell Group, SCG, operation in a wireless communications network 100, the method comprising any one or more out of:
determining 402 a preferred mode of operation associated to an SCG, which preferred mode of operation associated to SCG is e.g. anyone or more out of: an added SCG, an activated SCG, a deactivated SCG or a released SCG,
upon the fulfillment of a triggering condition, transmitting 403 to a network node 110, a message comprising the determined preferred mode of operation associated to the SCG.

Embodiment 2. The method according to embodiment 1, further comprising: receiving 401 a configuration from the network node 110, configuring the UE 120 to:
determining a preferred mode of operation associated to an SCG, and upon the fulfillment of a triggering condition, transmitting to the network node 110, a message comprising the determined preferred mode of operation associated to the SCG.

Embodiment 3. The method according to any of embodiments 1-2, wherein determining 402 a preferred mode of operation associated to an SCG comprises: determining whether an SCG is to be added, kept or released, and when determined that an SCG is to be added or kept, further determining whether the added or kept SCG is to be activated or deactivated.

Embodiment 4. A computer program comprising instructions, which when executed by a processor, causes the processor to perform actions according to any of the embodiments 1-3.

Embodiment 5. A carrier comprising the computer program of embodiment 4, wherein the carrier is one of an electronic signal, an optical signal, an electromagnetic signal, a magnetic signal, an electric signal, a radio signal, a microwave signal, or a computer-readable storage medium.

Embodiment 6. A method performed by a network node 110, e.g. for saving energy by handling Secondary Cell Group, SCG, operation in a wireless communications network 100, the method comprising any one or more out of:
upon the fulfillment of a triggering condition by a User Equipment, UE, 120, also referred to as a wireless terminal 120, receiving 502 from the UE 120, a message comprising a determined preferred mode of operation associated to an SCG.

Embodiment 7. The method according to embodiment 6, further comprising: transmitting 501 a configuration to the UE 120, configuring the UE 120 to:
determining a preferred mode of operation associated to an SCG, and upon the fulfillment of a triggering condition, transmitting to the network node 110, a message comprising the determined preferred mode of operation associated to the SCG.

Embodiment 8. A computer program comprising instructions, which when executed by a processor, causes the processor to perform actions according to any of the embodiments 6-7.

Embodiment 9. A carrier comprising the computer program of embodiment 8, wherein the carrier is one of an electronic signal, an optical signal, an electromagnetic signal, a magnetic signal, an electric signal, a radio signal, a microwave signal, or a computer-readable storage medium.

Embodiment 10. A User Equipment, UE 120, also referred to as a wireless terminal 120, e.g. configured to save energy by handling Secondary Cell Group, SCG, operating in a wireless communications network 100, wherein the UE 120 is further configured to any one or more out of:
determine, e.g. by means of a detecting unit in the UE 120, a preferred mode of operation associated to an SCG; which preferred mode of operation associated to SCG is adapted to be e.g. anyone or more out of: an added SCG, an activated SCG, a deactivated SCG or a released SCG,
upon the fulfillment of a triggering condition, transmit, e.g. by means of a transmitting unit in the UE 120, to a network node 110, a message adapted to comprise the determined preferred mode of operation associated to the SCG.

Embodiment 11. The UE 120 according to embodiment 10, further being configured to:
receive, e.g. by means of a receiving unit in the UE 120, a configuration from the network node 110, adapted to configure the UE 120 to:
determine a preferred mode of operation associated to an SCG, and upon the fulfillment of a triggering condition, transmit to the network node 110, a message adapted to comprise the determined preferred mode of operation associated to the SCG.

Embodiment 12. The method according to any of embodiments 10-11, wherein the UE 120 is further configured to determine a preferred mode of operation associated to an SCG by:
determine, e.g. by means of the determining unit in the UE 120, whether an SCG is to be added, kept or released, and
when determined that an SCG is to be added or kept, further determine, e.g. by means of the determining unit in the UE 120, whether the added or kept SCG is to be activated or deactivated.

Embodiment 13. A network node 110, e.g. configured to save energy by handling Secondary Cell Group, SCG, operation in a wireless communications network (100), wherein the network node 110 is further configured to any one or more out of:
upon the fulfillment of a triggering condition by a User Equipment, UE, 120, also referred to as a wireless terminal 120, receive, e.g. by means of a receiving unit in the network node 110, from the UE 120, a message adapted to comprise a determined preferred mode of operation associated to an SCG.

Embodiment 14. The network node 110 to embodiment 13, further being configured to:
transmit, e.g. by means of a transmitting unit in the network node 110, a configuration to the UE 120, adapted to configure the UE 120 to:
determine a preferred mode of operation associated to an SCG, and upon the fulfillment of a triggering condition, transmit to the network node 110, a message adapted to comprise the determined preferred mode of operation associated to the SCG.

### Further Extensions and Variations

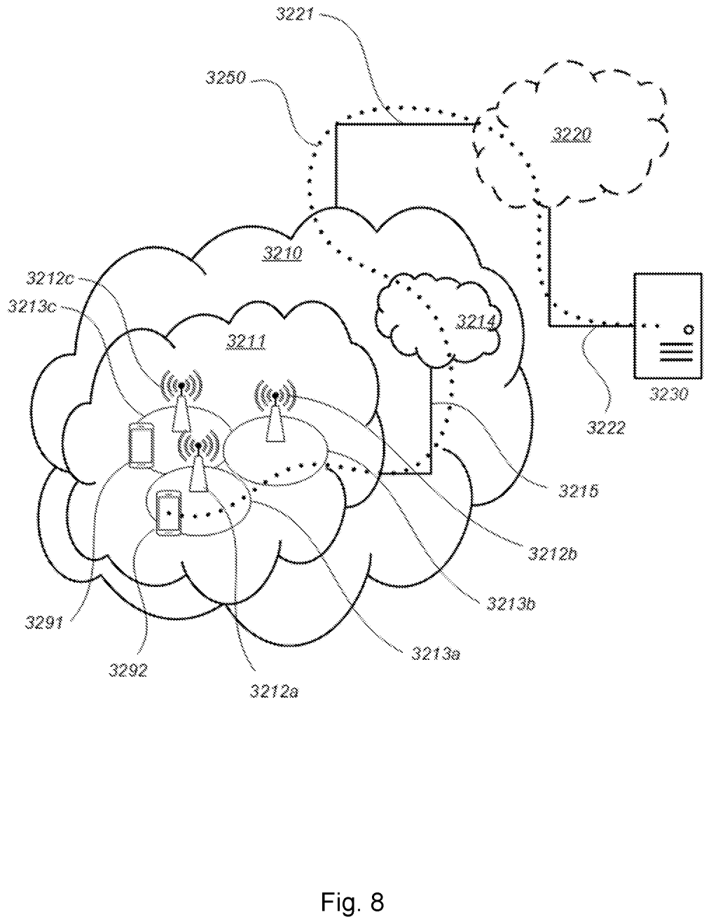

With reference to FIG. 8, in accordance with an embodiment, a communication system includes a telecommunication network 3210 such as the wireless communications network 100, e.g. an loT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

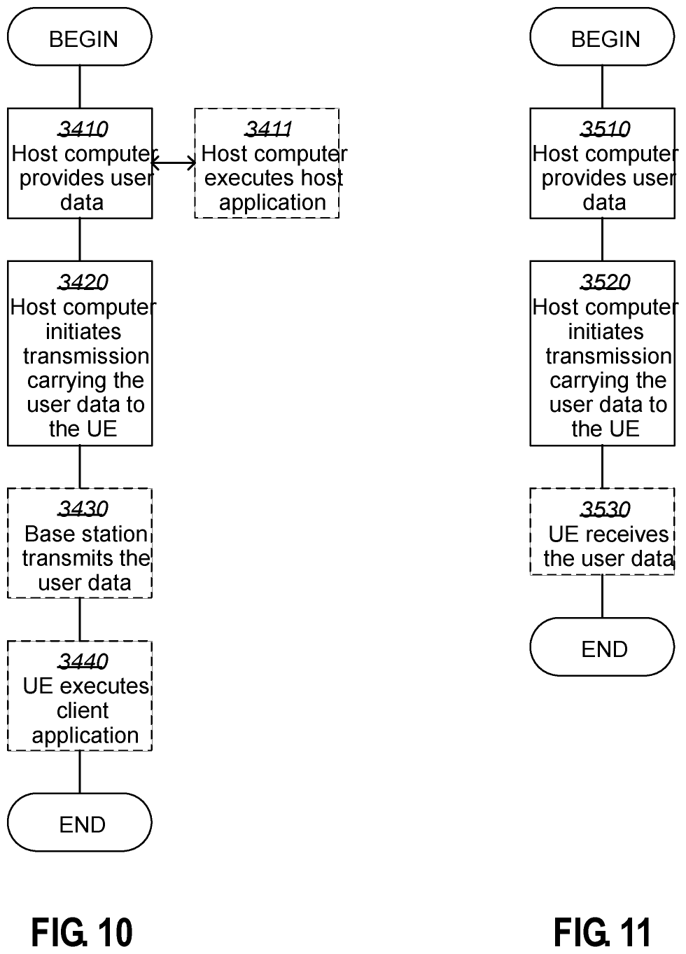

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

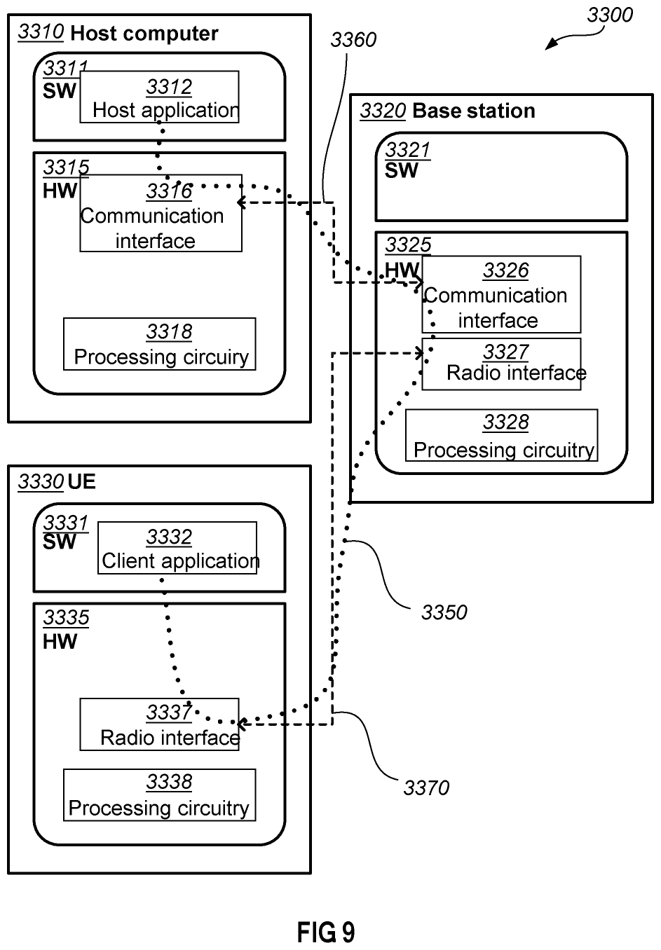

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 10, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 10 is a flowchart illustrating a method implemented in a communication system, in accordance with one embodiment. The communication system includes a host computer, a base station such as the network node 110, and a UE such as the UE 120, which may be those described with reference to FIG. 8 and FIG. 9. For simplicity of the present disclosure, only drawing references to FIG. 10 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 11 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

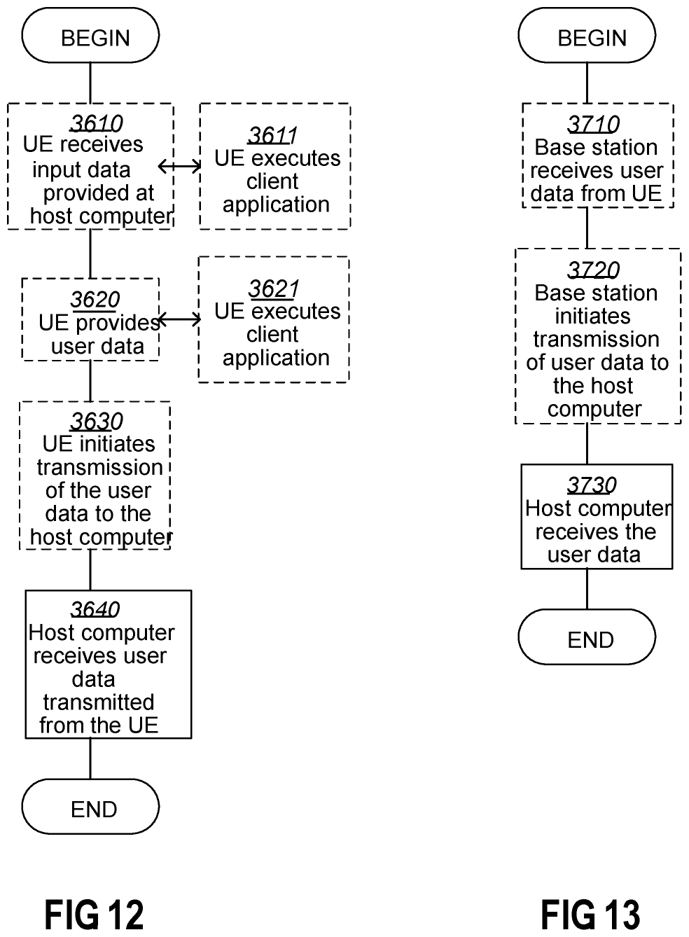

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1.-22. (canceled)

23. A method performed by a User Equipment (UE), for handling Secondary Cell Group (SCG) operation in a wireless communications network, the method comprising:
determining a preferred mode of operation associated to an SCG, and
transmitting, to a network node, a message comprising the determined preferred mode of operation associated to the SCG.

24. The method according to claim 23, wherein the preferred mode of operation associated to the SCG is anyone or more out of: an added SCG, an activated SCG, a deactivated SCG or a released SCG.

25. The method according to claim 23, wherein the transmitting the message is performed upon the fulfilment of a triggering condition.

26. The method according to claim 23, further comprising receiving a configuration from the network node, configuring the UE to transmit to the network node the message comprising the determined preferred mode of operation associated to the SCG.

27. The method according to claim 26, wherein the configuration further configures the UE to determine a preferred mode of operation associated to the SCG, and transmit the message upon the fulfilment of a triggering condition.

28. The method according to claim 23, wherein determining a preferred mode of operation associated to the SCG comprises:
determining whether an SCG is to be added, kept or released, and
when determined that an SCG is to be added or kept, further determining whether the added or kept SCG is to be activated or deactivated.

29. A method performed by a network node for handling Secondary Cell Group (SCG) operation in a wireless communications network, the method comprising:
receiving, from a User Equipment (UE), a message comprising a determined preferred mode of operation associated to an SCG.

30. The method according to claim 29, wherein the receiving is performed upon the fulfillment of a triggering condition by the UE.

31. The method according to claim 31, further comprising transmitting a configuration to the UE, configuring the UE to determine a preferred mode of operation associated to the SCG, and upon the fulfillment of a triggering condition, transmit to the network node, a message comprising the determined preferred mode of operation associated to the SCG.

32. A User Equipment (UE) configured to handle Secondary Cell Group (SCG) operation in a wireless communications network, wherein the UE comprises:
processing circuitry configured to:
determine a preferred mode of operation associated to an SCG, and
transmit, to a network node, a message adapted to comprise the determined preferred mode of operation associated to the SCG.

33. The UE according to claim 32, wherein the preferred mode of operation associated to the SCG is anyone or more out of: an added SCG, an activated SCG, a deactivated SCG or a released SCG.

34. The UE according to claim 32, the processing circuitry configured to transmit the message upon the fulfilment of a triggering condition.

35. The UE according to claim 32, the processing circuitry configured to:
receive a configuration from the network node configuring the UE to transmit, to the network node, the message comprising the determined preferred mode of operation associated to the SCG.

36. The UE according to claim 35, wherein the configuration configures the UE to determine the preferred mode of operation associated to the SCG, and transmit the message upon the fulfilment of a triggering condition.

37. The UE according to claim 32, wherein the processing circuitry is configured to determine a preferred mode of operation associated to an SCG by:
determining whether an SCG is to be added, kept or released, and
when determined that an SCG is to be added or kept, further determining whether the added or kept SCG is to be activated or deactivated.

38. A network node configured to handle Secondary Cell Group (SCG) operation in a wireless communications network, wherein the network node comprises:
processing circuitry configured to receive, from a User Equipment (UE), a message that comprises a determined preferred mode of operation associated to an SCG.

39. The network node according to claim 38, the processing circuitry configured to receive the message upon the fulfillment of a triggering condition by the UE.

40. The network node to claim 38, the processing circuitry configured to transmit a configuration to the UE that configures the UE to determine a preferred mode of operation associated to the SCG, and, upon the fulfillment of a triggering condition, transmit, to the network node, a message that comprises the determined preferred mode of operation associated to the SCG.
